(19) United States
(12) Patent Application Publication
(10) Pub. No.: US 2018/0137256 A1
(43) Pub. Date: May 17, 2018

(54) SYSTEM AND METHOD OF CALCULATING THE STRUCTURE AND PROPERTIES OF CHEMICALS

(71) Applicant: Paul MERRITHEW, Amherst, NH (US)

(72) Inventor: Paul MERRITHEW, Amherst, NH (US)

(21) Appl. No.: 15/353,076

(22) Filed: Nov. 16, 2016

(51) Int. Cl. G06F 19/00

(52) U.S. Cl. CPC G06F 19/701

(57) ABSTRACT

The system and method accurately models the stability and structure, and other properties, of chemical compounds. The method is general and requires less computation than other methods. The method is based on the assumption that bonding electrons, although of opposite spin, are not completely distinguishable. The method includes the relationships and criteria necessary to determine chemical bond lengths, angles and energies. The method also describes the derivation of the coefficients of hybrid bonding orbitals. The method also includes the relationships necessary to incorporate secondary, tertiary, and other interactions in the calculation of chemical properties.

### FIELD OF THE DISCLOSURE

The present disclosure relates to a method of modeling the stability and structure, and other properties, of chemicals, and more particularly, modeling the stability and structure of chemical compounds, metals, and semiconductors.

### BACKGROUND OF THE DISCLOSURE

Current methods utilized to calculate chemical properties are inaccurate, inconsistent, cumbersome and not generally applicable. They are not general in the sense that a method which produces fairly accurate energetics may give poor bond lengths. Worse, a method which may give reasonably accurate results for one compound, or group of compounds, cannot be applied successfully to other compounds. In particular, a method applied to poly-atomics would not apply to metals. Also, these current methods frequently consume enormous amounts of processing time, making the applicability of the methods to complex systems, such as those encountered in biology, problematic. The utility of current methods is also limited by their complexity. The typical experimentalist has neither the knowledge nor inclination to utilize them.

In contrast, the method of modeling the stability and structure of chemicals of the present disclosure is simple, accurate, and does not require significant processing time. In one embodiment, the present system treats bonding electrons, which have opposite spin, as not completely distinguishable when they overlap. The method utilizes relationships which result from this recognition of the partial indistinguishability of overlapping electrons resulting in a simpler, more accurate, general, and less computationally intensive calculation of chemical properties.

### SUMMARY OF THE DISCLOSURE

One aspect of the present disclosure is a computer program product, tangibly stored on a computer-readable medium, the product comprising instructions operable to cause a programmable processor to perform for modeling the stability and structure of a molecule comprising determining a geometry and an electronic configuration or pair of electronic configurations for a bond in a molecule; determining one or more central atom bonding hybrid orbital coefficients for polyatomic molecules; selecting a bond length; generating one or more atomic orbitals using at least two arrays; determining opposing hybrid orbital coefficients for terminal atoms; calculating potential energy terms; calculating an energy required to promote an s orbital to a p orbital; synchronizing a sigma bonding orbital to an opposite sigma bonding orbital; orthogonalizing a sigma bond orbital on a first atom to core electrons of an orbital on an opposite atom; calculating a core orthogonality energy penalty for a pair of sigma bonding orbitals; calculating sigma overlap for the pair or two pairs of sigma bonding orbitals; calculating fraction_bonding for the pair or two pairs of sigma bonding orbitals; calculating kinetic energy for the pair or two pairs of sigma bonding orbitals; calculating pi bonding; calculating secondary and tertiary interactions; determining if an alternate configuration or geometry is possible; and finalizing a model comprising the stability and structure of a molecule.

One embodiment of the computer program product is wherein the at least two arrays comprise a first array for kinetic energy and electron-nuclear attraction calculations and a second array for electron-electron repulsion calculations. In some cases, the first and second array are further divided into multiple sets of overlapping subarrays, finer arrays are used closer to a bond axis and coarser arrays are used farther from the bond axis and a bond center.

Another embodiment of the computer program product is wherein subarrays there are associated arrays comprising a position of an array element on a bond axis, a position outward along a radius, and a distance to a nuclei.

Yet another embodiment is wherein orthogonalizing a sigma bond orbital in a first atom to core electrons of an orbital on an opposite atom further comprises the steps of making node locations coincident and maintaining orbital density distribution.

Another aspect of the present disclosure is a method for modeling the stability and structure of chemicals comprising, determining a first geometry and an electronic configuration or pair of electronic configurations for a bond in a molecule; determining one or more central atom bonding hybrid orbital coefficients for polyatomic molecules; selecting a bond length; generating one or more atomic orbitals using at least two arrays; determining opposing hybrid orbital coefficients for terminal atoms; calculating potential energy terms; calculating an energy required to promote an s orbital to a p orbital; synchronizing a sigma bonding orbital to an opposite sigma bonding orbital; orthogonalizing a sigma bond orbital in a first atom to core electrons of orbital on an opposite atom; calculating a core orthogonality energy penalty for a pair of sigma bonding orbitals; calculating sigma overlap for the pair or two pairs of sigma bonding orbitals; calculating fraction_bonding for the pair or two pairs of sigma bonding orbitals; calculating kinetic energy for the pair or two pairs of sigma bonding orbitals; calculating pi bonding; calculating secondary and tertiary interactions; determining if an alternate configuration or geometry is possible; and finalizing a model comprising the stability and structure of a molecule.

One embodiment of the method is wherein at least two arrays comprise a first array for kinetic energy and electron-nuclear attraction calculations and a second array for electron-electron repulsion calculations. In some cases, the first and second array are further divided into multiple sets of overlapping subarrays, finer arrays are used closer to a bond axis and coarser arrays are used farther from the bond axis and a bond center.

Another embodiment of the method is wherein subarrays there are associated arrays comprising a position of an array element on a bond axis, a position outward along a radius, and a distance to a nuclei.

Yet another embodiment of the method is wherein orthogonalizing a sigma bond orbital in a first atom to core electrons of an orbital on an opposite atom further comprises the steps of making node locations coincident and maintaining orbital density distribution.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is a flowchart of one embodiment of the method of processing a bond according to the principles of the present disclosure.

### DETAILED DESCRIPTION OF THE DISCLOSURE

The energy of a chemical bond is determined by two terms, potential energy terms and kinetic energy terms. The potential energy terms include the nuclear-nuclear repulsion, the attraction of the electron on one atom to the nucleus of the other, and the electron-electron repulsion. These potential energy terms are calculated in a straight-forward manner via the application of Coulombs law. The kinetic energy terms relate to the degree that the electrons are constrained in space. Electrons that are confined in space have a high kinetic energy and would tend to lower the bond energy. Electrons that are less confined have a lower kinetic energy and would tend to stabilize the bond by raising the bond energy. Since overlapping electrons are less distinguishable than they were before overlapping, they are less constrained in space and have lower kinetic energy than they had prior to overlapping. The method embodied herein utilizes a unique calculation of the kinetic energy of bonding electrons to produce an accurate model of chemical structure and properties for use in a wide range of applications ranging from materials science to biochemical applications.

The application of partial indistinguishability of overlapping electrons has interesting ramifications. One ramification has to do with orthogonality. Bonding electrons must be orthogonal to the core electrons on the opposite atom. Also, the bonding electrons must be orthogonal to all of the valence electrons on the opposite atom except to the one with which it is paired. Orthogonalization constrains the electron, thereby increasing the kinetic energy. Unique to the method embodied in this disclosure, is that the energy penalty associated with orthogonalization, and/or the reconfiguration needed to orthogonalize the valence electrons, need only be taken to the extent at which the bonding electrons are distinguishable.

Another ramification of the focus on the overlap of bonding electrons has to do with the limit on overlap. It is understood that the overlap cannot exceed 100%. Overlap increases with the proximity of the bonding atoms. Because the bonding electron orbitals are usually hybrids or polarized atomic orbitals, overlap almost always reaches 100%. Bond energies almost always increase with overlap. The fact that the overlap cannot exceed 100% has the effect of limiting the proximity of the bonding atoms. Unique to the method embodied in this disclosure, is that bond lengths can usually be determined independent of the bond energy because the bond length is at the point where overlap reaches 100%.

The method described herein is also unique in that it considers that more than a single pair of electrons may have the appropriate symmetry for sigma bonding. This results in what is described herein as dual bonding or parallel bonding. Dual bonding and parallel bonding are not double bonds in the traditional sense, i.e., a sigma bond and a pi bond. Dual and parallel bonds as described herein are multiple sigma bonds.

Another unique feature of the method described herein is the recognition that the bonding orbital hybridization on the central atoms of poly-atomics is determined by the availability of s character. The s character of a bonding hybrid orbital is only considered “used” to the extent that the bonding orbitals are indistinguishable (e.g., half the time when the overlap is 100%). So, for example, the bonding orbital on carbon in CH₄ or diamond can be considered to have half s character (i.e. a traditional sp hybrid orbital). Similarly, the bonding orbitals in three-coordinate carbon can be considered to have ⅔ s character.

Another unique feature associated with the method embodied in this disclosure is the treatment of what are referred to as secondary, tertiary, and other interactions. One example of a secondary bond would be a H—H bond in H₂O. Although these secondary, tertiary bonds generally do not contribute directly greatly to the bond energy in poly-atomics, the secondary, tertiary overlap contributions do cause a lengthening in the bond, which does have a significant impact on the bond energy. Other methods which ignore secondary, tertiary, and other interactions result in poor approximations.

As discussed herein, the method of modeling chemical structure and properties provides an accurate prediction of chemical compounds. To begin, one must consider two atoms coming together forming a bond, one on the left (subscript 1) and another on the right (subscript r). The bonding orbitals on these atoms, designated ψ₁ and ψᵣ, have opposite spin. With the exception of hydrogen, this method of the present disclosure utilizes Slater-type atomic orbitals or hybrids of Slater-type atomic orbitals for the bonding orbitals. In the molecule, these atomic orbitals are only compressed slightly from those in the atom.

Orbital Overlap—Key to this method is overlap between the bonding electrons. To calculate this overlap, the atomic orbitals, ψ₁ and ψᵣ, need only to be made synchronous. Synchronous means that, at every position in space, the orbitals have the same sign. In other words, to be synchronous, ψ₁ must be positive where ψᵣ is positive and negative where ψᵣ is negative. The normalized synchronous orbitals are designated in italics ψ₁ and ψᵣ. The process utilized by this method to make bonding atomic orbitals synchronous also makes them orthogonal to the core electrons on the opposite atom. (The H atomic orbitals in H₂ are synchronous because neither has a node.) Overlap is calculated in the usual manner: overlap=∫∫∫ψ₁ψᵣ dr dθdϕ where overlap has a range from 0.0 to 1.0. From overlap, another quantity, fraction_bonding, is calculated:

fraction_bonding=overlap/(1.0+overlap).

In the sense that the term “bonding” is used herein, a bonding orbital never is more than 50% bonding, so fraction_bonding never exceeds 0.5 (50%) as the overlap cannot exceed 1.0. Except for the bonds in some simple molecules between “soft” atoms (H₂, for example) fraction_bonding generally reaches the limit of 0.5. The limitation on overlap makes it possible, in many cases, to determine bond lengths without a complete treatment of bond energy. With a few exceptions, bond energy increases as the bond length decreases until fraction_bonding=0.5 is reached.

For the purposes of this disclosure, a bond will be said to be “bonding” for fraction_bonding and “not bonding” for 1−fraction_bonding. Generally, then, a bond is 0.5 bonding and 0.5 not bonding. Also note that the two bonding atoms should not be considered bonding or not bonding simultaneously.

Kinetic Energy—To calculate the kinetic energy reduction associated with the overlap of the atomic orbitals, the method of the present disclosure constructs a combined orbital. A combined orbital has the same electron density as the two atomic orbitals, ψ₁ and ψᵣ, combined and is designated ψ₁₊ᵣ. It is formed taking the square root of the sum of the electron densities associated with ψ₁ and ψᵣ. Where ψ₁ and ψᵣ are negative, a negative sign is given to the combined orbital. The combined orbital has an associated charge of 2.0. Kinetic energy (KE) is determined in the usual manner:

KE=∫∫∫ψ∇²ψdr dθdϕ, where ∇² is the Laplacian.

To find the net kinetic energy saving associated with bonding the atomic orbitals, this method determines the kinetic energy of ψ1 and ψᵣ and the combined orbital ψ₁₊ᵣ. These kinetic energies are designated KE_{ψl} and KE_{ψr} and KE_{ψl+r} respectively. The kinetic energy reduction associated with overlap is designated KE_{bond}. This method determines KE_{bond} via the following expressions:

KEₙₑₜ=KE_{ψl+r}−KE_{ψl}−KE_{ψr} and KE_{bond}=fraction_bonding·KEₙₑₜ

where the total kinetic energy reduction for the bond is 2.0 times KE_{bond}. Here, KE_{bond} is for one electron.

Potential Energy Terms—These are the attraction of the electrons on the left to the nucleus on the right, the attraction of the electrons on the right to the nucleus on the left, the repulsion between the left and right side electrons and the mutual nuclear-nuclear repulsion. These are calculated in the usual manner using the atomic orbitals, ψ₁ and ψᵣ. The formulas used for the potential energy contributions to the total bond energy are described in more detail below.

Atomic Orbitals—For the purposes of developing and testing this method, the Slater-type atomic orbitals of Duncanson and Coulson [Duncanson, W. E and Coulson, C. A., Proc.Roy.Soc.(Edinburgh), 62,37(1944)] have been utilized. These atomic orbitals are mutually orthogonal. Any set of mutually orthogonal orbitals could be used. This relatively straightforward set gives satisfactory results.

In the formation of molecules this method increases the quantities Duncanson and Coulson call μ and μc (These are equivalent to the effective nuclear charge for 2s and 2p electrons), by factors (called “fact” herein) ranging from 1.0 to 1.06. Shrinking an atomic orbital raises an atom's energy but usually enables a stronger bond. This method includes a facility to estimate the energy impact of these small changes in the atomic parameters. Using these data, this invention is usually able to optimize “fact” for atoms in the bond to within ±0.005.

This method handles hydrogen differently from other atoms. Hydrogen atoms in molecules must be polarized and compressed significantly from the free atom. For the purposes of developing and testing this method, between 0.008 and 0.04 2p_{z} (with effective nuclear charge from 2.8 to 3.0) is usually added to the hydrogen 1s orbital to polarize it (0.08 is added in H₂O). Other methods of polarization could be used. The effective nuclear charge of the hydrogen is orbital is optimal in the range of 1.08 to 1.17.

Numerical Methods—This method performs the calculations described herein using numerical methods with the electron distributions represented as arrays. As a practical matter, because most bonds have axial symmetry, or can be treated as if they did, two dimensional arrays can be used to represent and yr. The numerical methods used by this method and the various techniques the method uses to speed the calculations are discussed in more detail below.

Orthogonalization—Consistent with the Pauli principle, the orbitals of electrons of the same spin must be orthogonal. When the left atom presents a bonding orbital to the right atom, (and correspondingly, when the right atom presents a bonding orbital to the left atom,) two types of changes must be made to meet orthonormality requirements.

Core Orthogonalization—When the left atom presents a sigma bonding orbital to the right atom, the bonding orbital on the left atom must be made orthogonal to the “core” electrons on the right atom. (Except if the opposite atom is H or He which has no core electrons.) The method of the present disclosure refers to this as core orthogonalization. Orthogonality is required because the core electrons are always spin paired. This method makes the sigma bonding electron orthogonal to the opposite core by putting a node in the bonding orbital. The process by which this method makes the orbital orthogonal to the core electrons also makes it synchronous with the opposing bonding orbital. The procedure that this method follows is discussed in more detail below.

Valence Orthogonalization—When the left atom presents a bonding orbital to the right atom, the right atom must change/reconfigure so that the orbitals on the right atom, with the exception of its bonding orbital, are orthogonal to the bonding orbital of the left atom. This disclosure refers to this as valence electron orthogonalization. Atoms with two s electrons need to reconfigure or hybridize one of the s electrons to meet the requirement. Sometimes an atom has more than one p orbital which has sigma symmetry (p_{z}). These p orbitals need to reconfigure to orthogonalize.

Opposing Orbital Orthogonalization—This method orthogonalizes orbitals in diatomic molecules (e.g. C₂, N₂, CN, etc.) or terminal atoms in poly-atomics (e.g. N in HCN or F in CF₄) by forming hybrid orbitals from their second s orbital. Hybrid orbitals are linear combinations of atomic orbitals. These take the form fsₒ s−fpₒp_{z}, where fsₒ and fpₒ are variable coefficients (fsₒ stands for fraction s opposing.) and fsₒ·fs₀=1.0−fpₒ·fpₒ. Throughout this description, the term “opposing” refers to orbitals or electrons on a bonding atom which are directly opposite from the bonding orbital on the same atom. In certain embodiments of the present disclosure, the coefficients fsₒ and fpₒ are adjusted to make the extra electron orbital orthogonal to the bonding orbital on the opposite atom (ψ₁ and ψᵣ [not ψ¹ and ψᵣ]). These calculations are discussed in more detail below. fsₒ·fsₒ is nominally 0.5 but usually fsₒ·fsₒ is somewhat different than fpₒ·fpₒ to meet the orthogonality requirement. The coefficients of the bonding hybrid orbitals, fs_{b} and fp_{b}, on the terminal atom are determined by fsₒ and fpₒ as fs_{b}=fpₒ and fp_{b}=fsₒ.

s to p_{⊥} Orthogonalization—this method considers that multi-coordinate atoms can orthogonalize the second s electron by reconfiguring it as a p_{xy} orbital. Herein, p perpendicular (p_{⊥}) or p_{xy} refers to orbitals perpendicular to the bond axis. These become p when forming a pi bond. In certain embodiments, the following reconfigurations s⇒p_{⊥} or s⇒p_{xy} or s⇒p_{π} are used. This s to p_{⊥} orthogonalization occurs in BO₂, CO₂, benzene, graphite, and in the traditional “double” or “triple” bonds (e.g. HCCH, H₂CCH₂ HCN), for example. The additional energy needed to promote the s completely to a p is spread among several bonds and the p orbital becomes available to pi bond.

s to Bonding Hybrid Orthogonalization—According to the present method, multi-coordinate atoms sometimes promote the second s electron to a p, orthogonalizing while at the same time creating an additional sigma bonding position. This occurs in BF₃, CH₄, diamond and H₃CCH₃, for example. In this case, where the orthogonalized orbital becomes sigma bonding, the reconfiguration is 100%.

s to Non-Bonding Hybrid Orthogonalization—According to the present method, multi-coordinate atoms sometimes promote the second s electron partially to p to create traditional sp³ or sp² hybrid non-bonding orbitals which are orthogonal to the bonding orbital of the opposite atom. Some exemplary compounds in this category are H₂O and

Orthogonalization via Node Formation—According to the present method, occasionally, the second s electron remains in place and a node is placed in the orbital to make it orthogonal to the opposite bonding orbital. This occurs in He₂+. Occasionally, a second bonding fs_{b} s+fp_{b}p_{z}, hybrid orbital remains in place and a node is placed in it. Here, the subscript b indicates bonding. This occurs in F₂, for example. This is discussed with respect to parallel bonding below.

Orthogonalization via p_{z} to p_{xy} Reconfiguration—According to the present method, sometimes atoms with more than three p orbitals configure two of the p orbitals as p_{z}. To orthogonalize, one of the p_{z} orbitals reconfigures as a p_{xy} (p_{z}⇒p_{xy}). In this category is O₂, for example.

Orthogonalization Energy—An important feature of the current method is that changes required to meet orthogonality requirements need only be made to the extent that the bond is not bonding (i.e. [1.0−fraction_bonding]). This means, that in the limit of fraction_bonding 0.5, the orthogonality changes are only taken by half. In the limit of fraction_bonding 0.5, the energy penalty paid to orthogonalize, is halved. For example, if the kinetic energy of a bonding orbital is raised by the quantity KE_{core}_{_}ₒᵣₜₕₒ=KE_{ψ}−KE_{ψ} to make it orthogonal to the opposite atoms core then this invention calculates:

energy loss to the bond=(1.0−fraction_bonding)·KE_{core}_{_}ₒᵣₜₕₒ

If a p_{z} orbital is reconfigured to p_{xy} to make it orthogonal, then this method, in the potential energy calculations, considers the electron to be a p_{z} orbital for fraction_bonding and a p_{xy} orbital for (1.0−fraction_bonding). Likewise, if an s orbital is reconfigured to a fsₒ s−fpₒp_{z} hybrid to become orthogonal, then this method considers, in the potential energy calculations, the electron to be an s orbital for fraction_bonding and a fsₒ s−fpₒp_{z} hybrid orbital for (1.0−fraction_bonding). In this latter case, the bond energy is also adjusted for the energy required to promote the s to a p. If the energy to promote an s to a p is given by stop, then the bond energy is decreased by stop·fpₒ·fpₒ·(1.0−fraction_bonding). Another very important feature of the current invention is that: the various bonding orbitals on the central atom of a polyatomic need only be mutually orthogonal to the extent that they are bonding.

Central Atom Bonding Hybrid Orbitals Central—atoms in poly-atomics are different from atoms in diatomic molecules or terminal atoms in poly-atomics. The latter form hybrid opposing orbitals of the form fsₒ s−fpₒp_{z} to orthogonalize their second s electron. These opposing orbitals in terminal atoms dictate the form of the bonding orbitals. This method determines the hybridization of bonding orbitals on atoms that are not in the terminal position, differently, via the availability of s character.

Three-coordinate atoms that orthogonize their second s electron by reconfiguring it as a p orbital, such as BF₃, CH₃ and graphite, have fs_{b}·fs_{b}=0.667. The s character in the bonding orbital cannot be oversubscribed, so 3·0.5·fs_{b}·fs_{b}≤1.0 and fs_{b}·fs_{b}=0.667. s character in a bonding orbital is maximized because this leads to a lessor orbital overlap and a shorter bond. With rare exceptions, shorter bonds lead to higher bond energies (F₂ is an exception.). According to the present method, three-coordinate atoms that are asymmetric can favor one or two of the three bonds (usually the ones with the possibility for pi bonding) over the other. So, fs_{b}·fs_{b}=0.75 for the CC bonds in benzene (C₆H₆) and fs_{b}·fs_{b}=0.5 for the CH bond. In H₂CCH₂ fs_{b}·fs_{b}=0.8125 for the CC bond and fs_{b}·fs_{b}=0.5938 for the CH bonds.

According to the present method, two-coordinate atoms that orthogonize their second s electron by reconfiguring it as a p orbital, such as BO₂ and CO₂ have fs_{b}·fs_{b}=0.75. In this case, the s character of the bond is limited because, when both sides are not bonding, 0.25 of the time, fs_{b}·fs_{b} must equal 0.5. In HCCH, fs_{b}·fs_{b}=0.875 for the favored CC bond and fs_{b}·fs_{b}=0.625 for the CH bond.

Four-coordinate atoms or pseudo four-coordinate atoms (those which have a combination of four lone pairs and bonds) have fs_{b}·fs_{b}=0.5. Examples of four-coordinate atoms are those in CH₄, CF₄ and diamond. In H₃CCH₃, the CC bond takes precedent, so that fs_{b}·fs_{b}=0.641 for the favored CC bond and fs_{b}·fs_{b}=0.453 for the CH bonds. The determination of fs_{b}·fs_{b} in general and its rationale is discussed in more detail below.

There are instances where the sigma bonding configuration does not include a p_{z} orbital. These include Li₂+, Li_{z}, B₂, C₂+ and C₂. According to the method of the present disclosure, the bonding s orbital in hybridizes with a variable, additional, relatively small amount (0.05 to 0.22) of p_{z}. There are some bonds where the available p orbital(s) is (are) configured as p_{π}. The remaining bonding s orbital is never-the-less hybridized with a relatively small amount of additional p_{z}. Examples of this are B₂, C₂+ and C₂. In Li (metal) the s orbital is neither polarized nor hybridized (The Li bonds in 3 dimensions.).

Dual and Parallel Sigma Bonding—This method considers that many atoms exhibit more than one orbital which have the appropriate symmetry for sigma bonding. These include atoms in diatomic molecules (B₂, C₂, N₂, O₂, F₂, BN, CN, etc.). Also, atoms in many poly-atomics exhibit more than one orbital which has the appropriate symmetry for sigma bonding. These, second, sigma bonding orbitals in poly-atomics are available to the extent that the coordinate (other bonds to the same atom) sigma bonds are bonding. For example, in HCCH, the second s orbitals in C are available for sigma bonding if the adjacent HC bond is bonding (0.5 of the time). Consequently, there is the possibility for a second sigma bond when both of the HC bonds are bonding (0.25 of the time).

The bonding that occurs between these second sets of sigma orbitals is referred to as either dual bonding or parallel bonding depending on its nature. Parallel bonding differs from dual bonding in that the second set of bonding orbitals does not reconfigure when the bond is not bonding. These dual/parallel bonds are not double bonds in the traditional sense, i.e. a sigma and a pi bond. These are two sigma bonds. In order to minimize confusion, this method calls these bonds dual or parallel bonds. Dual bonding is far more common than parallel bonding. Parallel bonding is exhibited in F₂ and partially in OF. These second sets of sigma orbitals involved in dual/parallel bonding can either increase or decrease the effective bond overlap and fraction_bonding. Dual bonding has a different impact on overall overlap than parallel bonding.

The quantitative impact of dual and parallel bonding on overall bond overlap and fraction_bonding will be discussed below.

Energy to Promote an s Orbital—In order to form hybrid bonding orbitals and/or reconfigure atomic orbitals to meet the orthogonalization requirement, this method promotes s orbitals to higher-energy, directional orbitals. For the first row atoms, on which we focus here, the promotion is from 2s to 2p. Through a combination of theoretical calculation and experience, a table of the energies required for the 2s to 2p promotion for the first row atoms has been developed for this method. These energies are dependent on the atom and symmetry of the orbital replacing the 2s orbital.

Pi Bonding—This method calculates the kinetic energy reduction associated with pi bonding, analogous to that of sigma bonding, with KE_{bond}_{_}_{π}=fraction_bonding_{π}·KEₙₑₜ_{_}_{π}, where, analogous with sigma bonding, KEₙₑₜ_{_}_{π}=KE_{combined}_{_}_{π}−KE_{π}_{_}₁−KE_{π}_{_}ᵣ and fraction_bonding_{π}=overlap_{π}/(1.0+overlap_{π}). Pi overlaps are much smaller than sigma overlaps, usually in the range of 0.1 to 0.3.

According to the present method, pi bonding only occurs to the extent that both pi bonding orbitals in a poly-atomic have the appropriate symmetry. Pi bonding in poly-atomics is also reduced by pi orbital sharing as in benzene (C₆H₆) and graphite (—C₂CC₂—).

Secondary, Tertiary and Etc. Bonding—According to the present method, in poly-atomic molecules, bonding occurs not only to the closest atom, but also to all atoms in the molecule with which it significantly overlaps. In non-metals secondary (tertiary) bonding is reduced by the least bonding of the primary (primary plus secondary) bonds and the primary bond axis is retained for the secondary and tertiary bonds. In metals bonding is calculated along the Cartesian axes and all bonds are reduced by the limit of bonding (0.5). In metals, overlaps to both nearest neighbors and next-nearest, etc. neighbors are considered. The quantitative impact of secondary, tertiary and etc. bonding will be discussed below.

Resonance—According to the present method, resonance can take many forms. For a bond of the form LR, there can be a full resonance with electrons on both L and R free to move: [L−R+, LR, L+R−]. With both left and right electrons free to move, L−R+ and L+R− occur 25% of the time and LR 50%. This method indicates the relative populations of the various species in this case as [0.25, 0.5, 0.25]. Alternatively, there can be resonance with only the left L or R electron free to move: [L−R+, LR] or [L+R−, LR] with the populations [0.5, 0.5]. According to the present method, usually the resonance is not simply one of the above, but a combination of the two. For example, HF exhibits a full resonance [H+F−, HF, H−F+] in combination with [H+F−, HF] approximately in the ratio of 0.5:0.5. The resulting populations of [H+F−, HF, H−F+] are about [0.375, 0.5, 0.125]. This resonance reflects the greater stability of H+F− versus H−F+. Frequently encountered also is a partial one-sided resonance of the form [L−R+, LR] or [L+R−, LR] where the charged species occurs less than half of the time. For example in HCN, the methods described in this method find that there is resonance [HC+N−, HCN] with the populations about [0.25, 0.75].

The resonance can be a sigma resonance with a sigma electron moving between the bonding atoms. This method recognizes that the resonance can also be a pi resonance. For example, HF (and HO, HN, HC and HB) exhibits a sigma resonance. The HCN resonance described above is a pi resonance. The methods embodied in this invention find that there is a full pi resonance, with both the C and O pi electrons resonating, in CO.

Resonance Energy—Recall that this method calculates the kinetic energy reduction associated with bonding as KE_{bond}=fraction_bonding KEₙₑₜ where KEₙₑₜ=KE_{combined}−KEₚₛᵢ_{_}₁−KEₚₛᵢ_{_}ᵣ. When the bonding electron is free to move from the right bonding orbital to the left, or from the left to the right, fraction_bonding in this expression is 0.5. This method computes the kinetic energy reduction associated with resonance, KE_{bond}_{_}ᵣₑₛ, as KE_{bond}_{_}ᵣₑₛ=0.5·KEₙₑₜ. KE_{bond}_{_}ᵣₑₛ gives the kinetic energy reduction associated with a bonding electron which is completely free to move such as [L−R+, LR] (right electron freely moving) or [L+R−, LR] (left electron freely moving). With a single electron equally likely both on the right or the left, [L−R+, LR, L+R−], the bond stabilization is given by 2·KE_{bond}_{_}ᵣₑₛ. Resonance impacts the kinetic energy associated with a bond but does not change the overlapₜₒₜₐₗ(maximum)=1.0 criterion. Sigma resonance sometimes has an indirect impact on fraction_bonding and the overlap. This will be discussed below.

Combination Resonances—A resonance can be incomplete and the neutral species present for more than half the time. This results in a combination of [0, 1.0] (no resonance) and [0.5, 0.5]. Taking the proportion of [0.5, 0.5] as fraction_res and the proportion of [0, 1.0] as (1−fraction_res), the relative populations are [0.5·fraction_res, (1−0.5·fract_res)]. Because of an inherent ambiguity, the proportion to be considered resonating (“free”) can be enhanced/depressed relative to the proportion not resonating. The ambiguity arises because, when the bond is LR (as opposed to L−R+ or L+R−) the LR can be considered either as a component of [0, 1.0] or as a component of [0.5,0.5]. According to the present method, in the case where resonance stabilizes the bond, the electron can be considered resonating for fract_res plus fract_res·(1−fract_res), for fract_res≤0.25. Fract_res is only the nominal amount of resonance. According to the present method, the kinetic energy reduction is KE_{bond}_{_}ᵣₑₛ for fract_res+fract_res·(1−fract_res) and 2·KE_{bond} for (1−fract_res)·(1−fract_res), for fract_res≤0.25. In the case where no resonance leads to a more stable bond, the electron can be considered resonating for only fract_res·fract_res, for fract_res≤0.25. In this case, the kinetic energy reduction is KE_{bond}, for fract_res′fract_res and 2·KE_{bond} for (1−fract_res)+fract_res·(1−fract_res), for fract_res≤0.25. Similar expressions apply to a full resonance [L−R+, LR, L+R−] in combination with a [L−R+, LR] or [L+R−, LR] resonance. Resonating anionic species (L− or R−) with two sigma electrons, exhibit partial parallel bonding. The quantitative impact of resonance on fraction_bonding and overlap will be discussed below.

The energy associated with the formation of a positively charge species in a resonance is obtained from tables of ionization potentials. The energy associated with the formation of negatively charged species is obtained from tables of electron affinities.

Key to the present method is the bonding orbital overlap and the related quantity, fraction_bonding, which is overlap/(1+overlap). Since overlap cannot exceed 1.0, fraction_bonding cannot exceed 0.5. Bond lengths are generally found at the point where the interatomic distance reaches fraction_bonding=0.5. The kinetic energy of the bonding electrons is fraction_bonding times the kinetic energy of combined orbital. In certain embodiments, the combined orbital is derived as the square root of the sum of the electron densities of the two bonding orbitals. The method introduces the concept of the dual bonding, which entails two sigma bonds. These dual bonds occur when the bonding atoms' configuration includes more than one orbital with sigma symmetry. Dual bonds impact the calculation of fraction_bonding, overlap and the kinetic energy of the bond. Bonding orbitals need to be made orthogonal to the core electrons on the opposite atom and also to the valence electron orbitals on the opposite atom. This method takes the energy penalty associated with these orthogonalizations/reconfigurations only to the extent of (1−fraction_bonding). The method incorporates Slater-type atomic orbitals, only slightly compressed from the free atom, as bonding orbitals.

This method is applicable to exploring the feasibility of synthesizing a molecule, or modifying a molecule, of potential pharmaceutical interest. It could be utilized to assess the stability and structure of potential intermediates in the synthesis of such molecules as well. This method might also be utilized to assess the stability and structure of potential new alloys or semiconductors. The method would give some insight into the electrical conductivity of the various proposed materials. In general, this method would allow much exploratory chemistry, which is currently performed in the laboratory, to be performed on a digital computer faster, less expensively, and with less skilled personnel than is presently the case, saving countless dollars and man hours of R&D time in a wide array of technical fields.

This invention is a system and method for the calculation of chemical properties and structure. This method determines basic structure (linear, trigonal, tetrahedral, and etc.) by finding the most stable structure from among the alternatives. This method determines the bond length, usually, as that length for which fraction_bonding=0.5. In the unlikely event that the greatest bond energy is obtained at fraction_bonding<0.5 (usually a bond to hydrogen), the length with the best bond energy is the bond length. This method determines the bond energy, bond length, bond angles and other chemical properties.

Using a typical set of array elements such as those described in the Generate Atomic Orbitals section below, calculated bond lengths are typically accurate to ±0.005 Å. One exception is bonds to hydrogen where the calculated values tend to be high by about 0.02 Å. Total bond energies are generally accurate to 1 or 2%. Results for bonds to “soft” atoms (H, light elements.) tend to be less accurate than those to “hard” atoms.

This method entails twelve steps: 1) Determine Geometry and Electronic Configurations, 2) Determine Central Atom Bonding Hybrid Orbital Coefficients (Poly-atomics), 3) Select a Bond Length, 4) Generate Atomic Orbitals, 5) Determine Opposing Hybrid Orbital Coefficients (Terminal Atoms), 6) Calculate Potential Energy Terms, 7) Calculate Energy to Promote an s Orbital, 8) Make Orbitals Synchronous/Core Orthogonal, 9) Calculate Core Orthogonality Energy Penalty, 10) Calculate Sigma Overlap/Fraction_Bonding/Kinetic Energy, 11) Calculate Pi Bonding and 12) Calculate Secondary/Tertiary Interactions. In certain embodiments of the method, the steps subsequent to selecting a bond length are repeated for each bond length.

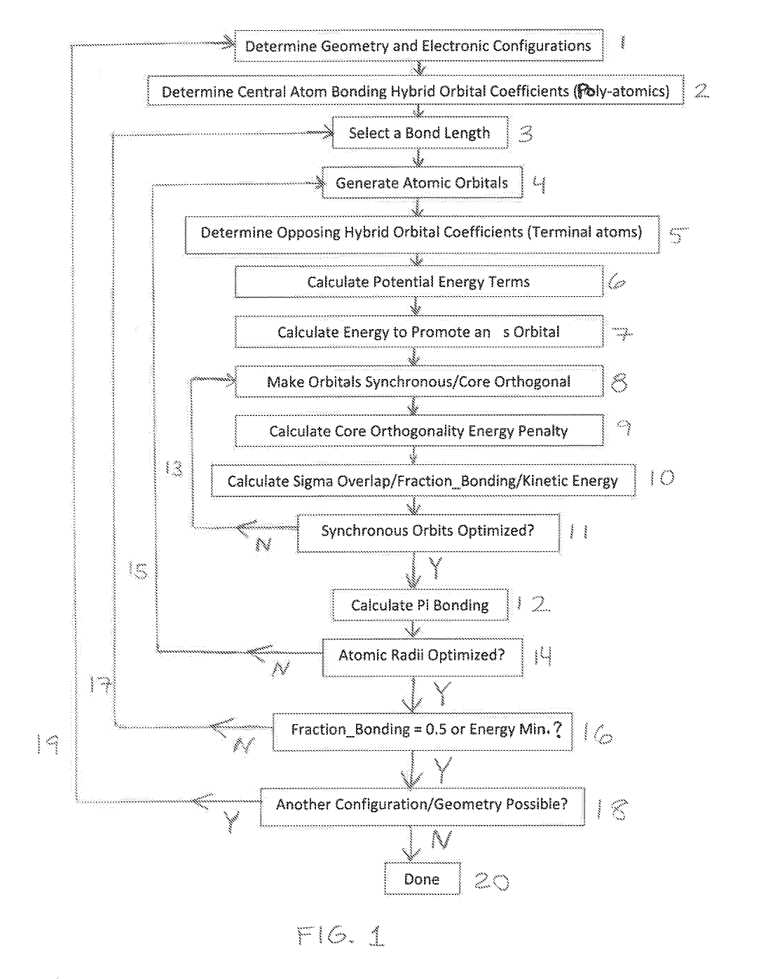

Referring to FIG. 1, one embodiment of the method of the present disclosure is shown. More particularly, a molecular simulation begins by determining the geometry and electronic configurations 1 as described herein. Next, the central atom bonding hybrid orbital coefficients (for poly-atomics) are determined 2. A bond length is selected for the simulation 3, and atomic orbitals are generated 4. The method then determines opposing hybrid orbital coefficients (for terminal atoms) 5 and calculates potential energy terms 6. The energy needed to promote an s orbital is then calculated 7. The orbitals are then made synchronous/core orthogonal 8. The core orthogonality energy penalty is then calculated 9 and the sigma overlap, fraction_bonding, and kinetic energy are calculated 10. If the synchronous orbitals are optimized 11 then the method proceeds to calculate pi bonding 12. If the synchronous orbitals are not optimized 13 then the core orthogonality and synchronous orbital step 8 is repeated. After calculating pi bonding 12, the atomic radii are optimized 14. If they are optimized, then an energy minimum is assessed as well as determining if fraction_bonding is equal to 0.5 16. If so, then the method is used to determine if there is another configuration or geometry possible 18 and repeats the step from the beginning 19. If not, the molecular simulation ends 20. If the fraction_bonding is not equal to 0.5 and an energy minimum has not been achieved 17 then a new bond length is selected and the method continues from that point on. Secondary and tertiary interactions are calculated and integrated into the above described steps as discussed herein to determine the most stable structure for a particular molecule. It is also possible to determine chemical properties of the various molecules for use in a variety of applications including biochemical applications, materials science, and the like.

Determine Geometry and Electronic Configurations—The method begins with selecting geometry and electronic configurations. Contrary to the traditional approach, the method embodied in this disclosure treats a molecule as typically having two electronic configurations, a bonding configuration and a not-bonding configuration. According to the present disclosure, the bonding configuration does not have to meet the valence orthogonality requirements. As explained above, a bond is typically bonding for half the time. The traditional Lewis structure (or Lewis dot structure) gives a high level view of the not-bonding configuration of a molecule.

Terminal atoms are those atoms on the periphery of a molecule which only bond to a single central atom (e.g. F in CF₄). Terminal atoms and atoms in diatomic molecules typically have a s²pⁿ configuration. According to the present disclosure, in its bonding configuration, these atoms retain the s² configuration. When n≤3, the bonding configuration is s²p_{z}p_{⊥}ⁿ⁻¹ (taking z as the bond axis). In the not-bonding configuration, the second s orbital becomes an opposing hybrid orbital as described in the Valence Orthogonalization section above. The not-bonding configuration in these cases is spₒs p_{z}p_{⊥}ⁿ⁻¹ where spₒ is the opposing hybrid orbital. (e.g., C₂, N₂, BN and CN are di-atomics which exhibit these structures.)

According to the present disclosure, if n>3, there will be two p electrons with sigma symmetry (e.g., two p_{z} orbitals.) in the bonding configuration. O₂ and O in NO are di-atomics which exemplify this characteristic and F in CF₄ and O in CO₂ are terminal atoms which are examples of this. The bonding configuration is s²p_{z}²p_{⊥}ⁿ⁻². In the not-bonding configuration the second s orbital becomes an opposing hybrid orbital as described above and the second p_{z} orbital becomes a p_{⊥}. The not-bonding configuration is then spₒsp_{z}p_{⊥}⁻¹. The two p_{z} bonding configuration is favored because a p_{z} orbital has a greater attraction for the opposite nucleus than a p₁ orbital.

The bonding configuration of O in a molecule is not always s²p_{z}²p_{⊥}². In CO, which exhibits a pi resonance [C−O+, CO, C+O−], O+ and O only have a single p_{z} in the bonding configuration. Some atoms with n=1 or 2 have the p orbitals configured as p_{⊥} in the bonding configuration. In these cases, the s orbitals are polarized by adding a small amount (typically about 5%) of p_{z} character to the s orbitals. (C₂ and B₂ are examples of this.)

This disclosure considers that it is possible that two orbitals with sigma symmetry remain in place in a not-bonding configuration. In this case, a node is placed in the second sigma orbital to make it orthogonal to the opposite sigma bonding electron. These in-place configurations are seen in conjunction with parallel bonding. An example of this is F₂ and BeO, but note, F₂ could not pi resonate if it reconfigured.

Some central atoms in poly-atomic molecules with no non-bonding electrons orthogonalize by promoting the second s entirely to p (both when bonding and not-bonding). This promotion also creates an additional bonding position. Three-coordinate central atoms are trigonal (an example is B in BF₃). Most common are four coordinate tetrahedral molecules (examples are diamond, C in CH₄ and CF₄). This disclosure considers that the ligand (i.e. the F in BF₃ or H in CH₄) “sees” the configuration of the central atom as sp_{z}p_{⊥} in three-coordinate case and as sp_{z}p_{⊥}² in four-coordinate case.

Two-coordinate central atoms which orthogonalize via s to p₁ have a bonding configuration of s²p_{z}p_{⊥}ⁿ and a not-bonding configuration of sp_{z}p_{⊥}ⁿ⁺¹. These molecules are linear. Such a configuration change favors pi bonding (or pi resonance). Some examples are C in CO₂, B in BO₂ and CC in acetylene (HCCH). In these molecules, where the central atom is two-coordinate, this disclosure places the central atom in the bonding configuration only to the extent that both of the ligand bonds are bonding (maximum=0.5·0.5). This disclosure also considers that for these two-coordinate central atoms, the second s electron is available for dual bonding only to the extent that the opposite bond is bonding (maximum=0.5).

Three-coordinate atoms which orthogonalize via s to p₁ are much more common. These molecules are trigonal or pseudo-trigonal. The bonding configuration is s²p_{z}p_{⊥}. The not-bonding configuration is sp_{z}p_{⊥}². In these molecules, where the central atom is three-coordinate, this method places the central atom in the bonding configuration only to the extent that all of the ligand bonds are bonding (maximum=0.5·0.5·0.5). This method also considers that for these three-coordinate central atoms, the second s electron is available for dual bonding only to the extent that both opposite bonds are bonding (maximum=0.5·0.5). Examples of molecules like these which contain three-coordinate central atoms are —C₂CC— in graphite [—C₂CCC₂—], H₂CC in ethylene [H₂CCH₂], carbonate ion [CO₃²⁻], nitrate ion [NO₃⁻] and methyl [CH₃]. Usually this type of structure results when advantaged by pi bonding, but not always (e.g., CH₃).

This method considers that non-bonding electron pairs on central atoms in polyatomic molecules are incorporated in traditional hybrid orbitals. In the case of a three-coordinate central atom with one non-bonding electron pair (called pseudo-tetrahedral herein), the non-bonding electron pair is incorporated, nominally, in a traditional sp³ hybrid orbital. The sp³ hybrid has the form, fsₒ s−fpₒp_{z}, where fsₒ·fsₒ is 0.25 and fpₒ·fpₒ is 0.75. The fsₒ·fsₒ and fpₒ·fpₒ values sometimes differ somewhat from the nominal to meet orthogonality requirements. This is discussed in more detail below in the section on bond angles. This method makes the central atom configuration in this case sp_{z}p_{⊥}^{2.5} spₒ^{0.5}, from the standpoint of each ligand, where spₒ is fsₒ s−fpₒp_{z}, with fsₒ·fsₒ=0.5 and fpₒ·fpₒ=0.5. From the standpoint of each ligand the non-bonding orbital is one half of an sp hybrid and one half p₁. The non-bonding electron pair only looks like an sp³ hybrid orbital from the standpoint of the molecular C₃ axis. This disclosure recognizes that the central atom bonding orbital, in this case, has fs_{b}·fs_{b}=0.5 and fp_{b}·fp_{b}=0.5, which is the same as the tetrahedral case, e.g., CH₄. An example of this configuration is ammonia (NH₃).

In the case of a two-coordinate with two non-bonding electron pairs (also called pseudo-tetrahedral herein), the non-bonding electron pairs are nominally incorporated in two traditional sp³ hybrid orbitals. These sp³ hybrids have the same nominal form as above, fsₒ s−fpₒp_{z}, where fsₒ·fsₒ is 0.25 and fpₒ·fpₒ is 0.75. According to the present disclosure, from the standpoint of each ligand, the central atom configuration, in this case, is s^{1.25}p_{z}p_{⊥}^{3.25}spₒ^{0.5} where spₒ is fsₒ s−fpₒp_{z}, with fsₒ·fsₒ=0.5 and fpₒ·fpₒ=0.5. According to the present disclosure, the central atom bonding orbital, in this case, has fs_{b}·fs_{b}=0.5 and fp_{b}·fp_{b}=0.5, which is the same as the tetrahedral case. An example of this configuration is water (H₂O).

In the case of a two-coordinate with one non-bonding electron pair (called pseudo-trigonal herein), the non-bonding electron pair is nominally incorporated in a traditional sp² hybrid orbital. The sp² hybrid has the nominal form, fsₒ s−fpₒp_{z}, where fsₒ·fsₒ=0.333 and fpₒ·fpₒ=0.667. According to the present disclosure, from the standpoint of each ligand, the central atom configuration, in this case, is sp_{z}p_{⊥}^{2.33}spₒ^{0.67} where spₒ is fsₒ s−fpₒ p_{z}, with fsₒ·fsₒ=0.5 and fpₒ·fpₒ=0.5. From the standpoint of each ligand the non-bonding orbital is two thirds of an sp hybrid and one third p_{⊥}. According to the present disclosure, the central atom bonding orbital, in this case, has fs_{b}·fs_{b}=0.667 and fp_{b}·fp_{b}=0.333, which is the same as the trigonal case, e.g. C in graphite. An example of this configuration is NO₂⁻.

Determine Central Atom Hybrid Orbital Coefficients—The second step in the method is to determine central atom bonding hybrid orbital coefficients in poly-atomics. This method determines the composition of central atom hybrid orbitals by the availability of s character. The s orbital cannot be oversubscribed. So the hybridization is determined by the expression: coordination number·0.5·fs_{b}·fs_{b}≤1.0. In four-coordinate compounds (or three-coordinate compounds with one lone pair or two coordinate with two lone pairs), where all ligand bonds are equivalent, such as CH₄ and diamond, fs_{b}·fs_{b}=0.5. However, in some compounds, such as H₃CCH₃, it is possible to give preference to one or more of the bonds. The logic for preference of one of the four bonds in a four-coordinate compound is illustrated in Table 1 below.

TABLE 1
Calculation of fs_{b} · fs_{b} for 4-coordination - one bond favored

| | | fs_{b} · fs_{b} contribution for | | |
|---|---|---|---|---|
| side/opposite side | probability | all same | favored for s | not favored |
| b 3b | 0.0625 | 0.25 | 1.0 | 0.0 |
| b 2b, 1nb | 3 · 0.0625 | 0.33333 | 0.66667 | 0.22222 |
| b 1b, 2nb | 3 · 0.0625 | 0.5 | 0.66667 | 0.44444 |
| b 3nb | 0.0625 | 1.0 | 1.0 | 1.0 |
| nb 3b | 0.0625 | 0.5 | 0.5 | 0.5 |
| nb 2b, 1nb | 3 · 0.0625 | 0.41666 | 0.41666 | 0.41666 |
| nb 1b, 2nb | 3 · 0.0625 | 0.66667 | 0.66667 | 0.66667 |
| nb 3 nb | 0.0625 | 0.5 | 0.5 | 0.5 |
| | 1.0 | 0.5 | 0.640625 | 0.453125 |

nb ≡ not bonding
b ≡ bonding
fraction bonding(b) = 0.5
fraction not bonding(nb) = 0.5

According to the present disclosure, three-coordinate atoms that orthogonalize their second s electron by reconfiguring it as a p orbital, such as BF₃, CH₃ and graphite, have fs_{b}·fs_{b}=0.667. Three-coordinate atoms that are asymmetric can favor one or two of the three bonds over the other. The logic for preference of one of the three bonds is illustrated in Table 2 below.

TABLE 2
Calculation of fs_{b} · fs_{b} for 3-coordination - one bond favored

| | | fs_{b} · fs_{b} contribution for | | |
|---|---|---|---|---|
| side/opposite side | probability | all same | one favored for s | not favored |
| b 2b | 0.125 | 0.33333 | 1.0 | 0.0 |
| b 1b, 1nb | 2 · 0.125 | 0.5 | 0.75 | 0.375 |
| b 2nb | 0.125 | 1.0 | 1.0 | 1.0 |
| nb 2b | 0.125 | 1.0 | 1.0 | 1.0 |
| nb 1b, 1nb | 2 · 0.125 | 0.75 | 0.75 | 0.75 |
| nb 2nb | 0.125 | 0.5 | 0.5 | 0.5 |
| | 1.0 | 0.66667 | 0.8125 | 0.59375 |

nb ≡ not bonding
b ≡ bonding
fraction bonding(b) = 0.5
fraction not bonding(nb) = 0.5

So, in H₂CCH₂ fs_{b}·fs_{b}(average)=0.8125 for the CC bond and fs_{b}·fs_{b}=0.5938 for the CH bonds. The logic for preference of two of the three bonds is illustrated in Table 3 below.

TABLE 3
Calculation of fs_{b} · fs_{b} for 3-coordination - two of three favored

| | | fs_{b} · fs_{b} contribution for | | |
|---|---|---|---|---|
| side/opposite side | probability | all same | two favored for s | not favored |
| b 2b | 0.125 | 0.33333 | 0.5 | 0.0 |
| b 1bf, 1nb | 0.125 | 0.5 | 0.5 | 0.0 |
| b 1b, 1nb | 0.125 | 0.5 | 1.0 | 0.0 |
| b 2nb | 0.125 | 1.0 | 1.0 | 1.0 |
| nb 2b | 0.125 | 1.0 | 1.0 | 1.0 |
| nb 1bf, 1nb | 0.125 | 0.75 | 0.5 | 0.75 |
| nb 1b, 1nb | 0.125 | 0.75 | 1.0 | 0.75 |
| nb 2nb | 0.125 | 0.5 | 0.5 | 0.5 |
| | 1.0 | 0.66667 | 0.75 | 0.5 |

nb ≡ not bonding
b ≡ bonding
bf ≡ bonding other favored
fraction not bonding(b) = 0.5
fraction bonding other favored (bf) = 0.5
fraction not bonding (nb) = 0.5

Or, more simply, for two preferred out of three, fs_{b}·fs_{b}(average)=1.0−probability of opposite also bonding [1-0.5·0.5=0.75]. So, fs_{b}·fs_{b}(average)=0.75 for the CC bonds in benzene (C₆H₆) and fs_{b}·fs_{b}=0.5 for the CH bond.

According to the present disclosure, two-coordinate atoms that orthogonalize their second s electron by reconfiguring it as a p orbital, such as BO₂ and CO₂, have fs_{b}·fs_{b}=0.75. In this case, the s character of the bond is limited because, when both sides are not bonding, 0.25 of the time, fs_{b}·fs_{b} must equal 0.5. The logic for preference of one of the two bonds is illustrated in Table 4 below.

TABLE 4
Calculation of fs_{b} · fs_{b} for two coordination - one favored

| | | | fs_{b} · fs_{b} contribution for | |
|---|---|---|---|---|
| side/opposite | probability | all same | favored for s | not favored |
| b b | 0.25 | 0.5 | 1.0 | 0.0 |
| b nb | 0.25 | 1.0 | 1.0 | 1.0 |
| nb b | 0.25 | 1.0 | 1.0 | 1.0 |
| nb nb | 0.25 | 0.5 | 0.5 | 0.5 |
| | 1.0 | 0.75 | 0.875 | 0.625 |

nb ≡ not bonding
b ≡ bonding
fraction bonding(b) = 0.5
fraction not bonding(nb) = 0.5

Or, more simply, for one preferred out of two, fs_{b}·fs_{b}(average)=1.0−probability of both sides not bonding [1−0.250.5=0.875]. In HCCH, fs_{b}·fs_{b}(average)=0.875 for the favored CC bond and fs_{b}·fs_{b}=0.625 for the CH bond. In HCN, fs_{b}·fs_{b}(average)=0.875 for the favored CN bond and fs_{b}·fs_{b}=0.625 for the CH bond.

According to the present disclosure, for two-coordinate atoms, fs_{b}·fs_{b}(average) is not limited simply by the availability of s as is the case for three-coordinate and four-coordinate atoms. Clearly, were the availability of s the only variable governing fs_{b}·fs_{b}fs_{b}·fs_{b} would be 1.0. That fs_{b}·fs_{b} must be 0.5 when both sides are not bonding, limits fs_{b}·fs_{b}(average) to 0.75. This has implications in the determination of the span of fs_{b}·fs_{b} which is discussed below.

The fs_{b}·fs_{b} values derived above are average values. Average fs_{b}·fs_{b} values suffice for calculations of bonding between an “unsaturated” atom and a “saturated” atom such as CN in HCN or CO in CO₂. According to the present invention, for bonds between “unsaturated” atoms, such as CC in H₂CCH₂ or CC in HCCH or CC in NCCN, accurate results require that the fraction_bonding calculations utilize two (or more) values for fs_{b}·fs_{b} which span the range of possible values. Fraction_bonding is calculated for each fs_{b}·fs_{b}. These fraction_bonding results are averaged to obtain the final result.

The span of fs_{b}·fs_{b} values chosen must reflect the actual span of possible values. For example, for CC in graphite fs_{b}·fs_{b}(average)=0.6667. The C in graphite has 0.6667-0.5 “excess” s. (0.6667−0.5)/2=0.0833. So, fs_{b}·fs_{b}=0.6667±0.0833 for graphite. For the favored CC bond in H₂CCH₂ fs_{b}·fs_{b}(average)=0.8125. 0.8125 represents a 0.8125−0.6667 advantage for the favored CC bond, (0.8125−0.6667)/2=0.07292. So, fs_{b}·fs_{b}=0.8125±0.07292 for CC in H₂CCH₂. For the favored CC bonds in benzene (C₆H₆) fs_{b}·fs_{b}(average)=0.75. In the case of H₂CCH₂, one bond on a three-coordinate atom can have a 0.8125−0.6667 advantage for the favored side. (0.8125−0.6667)/2=0.07292. So, fs_{b}·fs_{b}=0.75±0.07292 for CC bonds in benzene. For CC in HCCH fs_{b}·fs_{b}(average)=0.875. If CC were not favored over HC fs_{b}·fs_{b} could be 0.75. 0.5(0.875−0.75)/2=0.03125. The amount of “excess” s is cut in half in this two-coordinate case by the requirement that fs_{b}·fs_{b} must be 0.5 when both sides are not bonding. This gives rise to the 0.5 factor in 0.5 (0.875−0.75)/2=0.03125. So, fs_{b}·fs_{b}=0.875±0.03125 in HCCH. For the central, for two-coordinate, C in H₂CCCH₂ fs_{b}·fs_{b}(average)=0.75. The span fs_{b}·fs_{b}=0.75±(0.125+0.0625).

Select a Bond Length—The method of the present disclosure continues with the step of selecting a bond length. This method utilizes a list of possible bond lengths from which bond lengths are successively selected. If fraction_bonding=0.5 is not spanned, or an energy minimum is not found, then the list is modified and the modified list executed. When fraction_bonding=0.5 is spanned, then the result is refined by interpolation. Further refinement can be achieved by reducing the distance between successive bond lengths in the list. The steps described below are repeated for each bond length.

Generate Atomic Orbitals—This method derives chemical structures and energy and other molecular properties starting from Slater-type atomic orbitals. This method represents the atomic orbitals as large two-dimensional arrays. Two dimensional arrays suffice because bonds have axial symmetry, or the calculations can be performed as if the bond had axial symmetry. For example, in the ethylene molecule, H2CCH2, the CC bond does not have axial symmetry because it has a single p_{π} orbital perpendicular to the CC bond axis. This p orbital could be designated a pₓ or a p_{y} orbital depending on the definition of axes. This method treats the pₓ or p_{y} orbital as an axially symmetric [pₓ,p_{y}] combination but recognizes that constraining the orbital to a single axis changes the final kinetic energy calculation. The kinetic energy of a pₓ or p_{y} orbital is two times the energy calculated as if it were axially symmetric. One dimension of the arrays is along the bond axis. The second dimension is along the radius perpendicular to the bond axis.

For the purposes of developing and testing this method, the Slater-type atomic orbitals of Duncanson and Coulson were used. These atomic orbitals are all mutually orthogonal. Any set of mutually orthogonal orbitals could be used.

Key to the performance (speed of calculation) of the current method are three factors. First, two sets of arrays are used, one for the kinetic energy and electron-nuclear attraction calculations and another, courser set of arrays for the electron-electron repulsion calculations. Fortunately, the electron-electron repulsion calculations can be performed with less precision than the kinetic energy and electron-nuclear attraction calculations. The granularity of the arrays used in the kinetic energy calculation have to be fine enough to represent the orbital electron density smoothly. The electron-nuclear attraction calculation requires that array elements near the nuclei be small. Second, these arrays are broken into multiple sets of overlapping subarrays; fine arrays close to the bond axis and courser arrays further from the bond axis and further from the bond center. For each subarray, there are separate associated arrays containing the position of the array element on the bond axis, the position outward along the radius, and the distances to the nuclei. Third, the radial distance between each of every pair of subarray elements is contained in tables. The method of the present disclosure has a facility to generate these tables.

Typically, the arrays used by this method for kinetic energy calculations and electron-nuclear attraction calculations contain over 30,000 elements. The arrays used for electron-electron repulsion calculations have over 7,000 elements. Typical kinetic energy error is about 10⁻⁵ Hartree. Typical normalization error is about 10⁻⁵. Worst case electron-nuclear energy error is about 2×10⁻⁴ Hartree. In some cases, the electron-nuclear energy calculation is most prone to error. The errors quoted here are due to the approximation inherent in a limited array size. Calculation with much larger arrays, give much smaller errors (e.g., 10⁻⁸ Hartree).

Using a typical set of array elements, a typical set of bonding calculations at 6 different bond lengths takes a few seconds on an ordinary desktop computer (e.g., 3.3 Ghz, 4 MB RAM, etc.). This method is designed so that the distances associated with the arrays can be scaled up/down by changing a single parameter. Primary interactions which have a relatively short range can be performed at one scale while the longer, lessor, secondary interactions are performed at a larger scale. The array sizes, and therefore the accuracy of the calculations can be changed relatively easily by changing the array definition files.

Determine Opposing Hybrid Orbital Coefficients—The method then determines opposing hybrid orbital coefficients for terminal atoms. The s and p_{z} orbitals of a terminal atom hybridize to form an opposing orbital of the form fsₒs−fpₒp_{z}, and a bonding orbital of the form fs_{b} s+fp_{b}p_{z} where fsₒ·fsₒ+fpₒ·fpₒ=1. fsₒ and fpₒ are chosen to make the opposing orbital orthogonal to the opposite bonding orbital. Placing the opposing orbital on the right, fsₒᵣ and fpₒᵣ are chosen to satisfy the following:

fs_{bl}·fsₒᵣ·overlapₛ_{_}ₛ_{_}ₙ−fp_{b1}·fpₒᵣ·overlap_{pz}_{_}_{pz}_{_}ₙ+fsₒᵣ·fp_{bl}·overlap_{pz}_{_}ₛ_{_}ₙ−fpₒᵣ·fs_{bl}·overlapₛ_{_}_{pz}_{_}ₙ=0.0

The suffix_{—n} here indicates that the overlaps here are evaluated using the original, non-synchronous (not orthogonal to the opposite core) atomic orbitals. The right opposing orbital is, of course, also orthogonal to the right bonding orbital. Since fs_{br}=fpₒᵣ and fp_{br}=fsₒᵣ, the opposing orbitals determine the bonding orbitals. In the case of a diatomic, where both atoms are terminal atoms, fsₒᵣ and fpₒᵣ and fsₒₗ and fpₒᵣ are chosen to satisfy the simultaneous equations:

fs_{bl}·fsₒᵣ·overlapₛ_{_}ₛ_{_}ₙ−fp_{bl}·fpₒᵣ·overlap_{pz}_{_}_{pz}_{_}ₙ+fsₒᵣ·fp_{bl}·overlap_{pz}_{_}ₛ_{_}ₙ−fpₒᵣ·fs_{bl}·overlapₛ_{_}_{pz}_{_}ₙ=0.0 and

fs_{br}·fsₐₗ·overlapₛ_{_}ₛ_{_}ₙ−fp_{br}·fpₐₗ·overlap_{pz}_{_}_{pz}_{_}ₙ+fsₐₗ·fp_{br}·overlap_{pz}_{_}ₛ_{_}ₙ−fpₐₗ·fs_{br}·overlapₛ_{_}_{pz}_{_}ₙ=0.0.

Calculate Potential Energy Terms—This method calculates the bond energy potential energy terms from atomic orbitals which are little changed from those in the atom. The potential energy terms are the attraction of the electrons on the left to the nucleus on the right, the attraction of the electrons on the right to the nucleus on the left, the repulsion between the left and right side electrons and the mutual nuclear-nuclear repulsion. These are calculated in the usual manner. The nuclear-nuclear repulsion is given by nuclear_chargeₗ·nuclear_chargeᵣ/bl, where nuclear_chargeₗ is the charge on the left nucleus and nuclear_chargeᵣ is the charge on the right nucleus. The bond length is bl.

Other potential energy terms are calculated in the usual manner via the straightforward application of Coulombs law to the electron density arrays generated for the atomic orbitals on the left and right atoms. ψ₁ and ψᵣ (not ψ₁ and ψᵣ) are used in the calculation. In the discussion below, the potential energy associated with an electron's attraction to the opposite nucleus will be designated by ZE. For example, the attraction of a is electron on the right to the opposite nucleus on the left will be given by ZE₁ₛ_{_}_{z}. So, ZE₁ₛ_{_}_{z1}=nuclear_charge₁·∫∫∫ψ₁ₛᵣ 1/r₁ₛ_{_}_{zl} ψ₁ₛₗ dr dθdϕ, where r₁ₛ_{_}_{zl} is the radial distance between the is electron density element on the right and the nucleus on the left.

The electron-electron repulsion term is designated EEᵣ_{_}₁. For example, the repulsion between a 2s electron on the right and a 2s electron on the left is EE₂ₛ_{_}₂ₛ=∫∫∫ψ₂ₛᵣ 1/r₂ₛ_{_}₂ₛ ψ₂ₛₗ dr dθdϕ, where r₂ₛ_{_}₂ₛ is the radial distance between the 2s electron density element on left and the 2s electron density element on the right.

Calculate Energy to Promote an s Orbital—Through a combination of theoretical calculation and experience, a table of the energies required for the 2s to 2p promotion for the first row atoms has been developed for this method. These energies are given, in Hartrees, in Table 5, below. Several values can be given for each atom depending on the configuration of the resulting p orbital. For example, a carbon 2s electron can be promoted to 2p to make four bonding tetrahedral orbitals (as in diamond or CH₄), or a 2s orbital can be promoted to a 2p_{π} (as in HCCH or H₂CCH₂), or promoted to form an opposing spₒ hybrid (as in C₂ (unpaired) or CO (paired)). In the table spₒ designates an opposing sp hybrid (can be paired or unpaired/it is considered paired if the configuration includes an s and p_{z}), spₒ² designates two spₒ hybrids which are paired together (no s and p, in the configuration).

TABLE 5

| Species | 2p Orbital Type | stop Energy (in Hartree) |
|---|---|---|
| Be+ | spₒ (unpaired) | 0.070 |
| Be | spₒ (unpaired) | 0.100 |
| Be | p_{⊥} (metal) | 0.095 |
| B+ | p_{⊥ or π} | 0.180 |
| B+ | spₒ² (paired) | 0.220 |
| B | spₒ (unpaired) | 0.160 |
| B | p_{⊥ or π} | 0.210 |
| B | spₒ (paired) | 0.240 |
| C+ | T_{d} | 0.195 |
| C+ | p_{π} | 0.200 |
| C+ | spₒ (unpaired) | 0.160 |
| C+ | spₒ² (paired) | 0.315 |
| C | trigonal (unbonded) CH₂ | 0.255 |
| C | T_{d} | 0.240 |
| C | spₒ (unpaired) | 0.240 |
| C | p_{⊥} (unbonded) CH₃ | 0.255 |
| C | p_{π} | 0.275 |
| C | spₒ (paired) | 0.275 |
| N+ | spₒ (paired) | 0.390 |
| N+ | spₒ² (paired) | 0.420 |
| N | spₒ (paired) | 0.455 |
| N | p_{π} | 0.455 |
| O+ | spₒ (paired) | 0.455 |
| O+ | spₒ² (paired) | 0.575 |
| O | spₒ (paired) | 0.610 |
| O− | spₒ (paired) | 0.610 |
| F | spₒ (paired) | 0.610 |

Typically, about 0.5 of the 2s to 2p energy (referred to as stop), for each atom in the bond, is charged to the bond energy. For example, in diamond, one 2s is promoted to 2p to form four bonding orbitals for one of the two atoms that bond. So, 20.25=0.5 of the 2s to 2p energy is charged to each bond. In N₂, an spₒ opposing orbital is formed to meet the orthogonalization requirement. The 2p content (fpₒ·fpₒ) of this orbital is about 0.5 and orthogonalization is required for 0.5. Therefore about 2·0.5·0.5=0.5 of the 2s to 2p energy is charged to the N₂ bond energy for 2s to 2p promotion.

Make Orbitals Synchronous/Core Orthogonal—The process that this method uses to make a sigma bonding orbital orthogonal to the core electrons of the opposite atom also makes the bonding orbital synchronous with the bonding orbital of the opposite side. This method follows two rules in forming these synchronous bonding orbitals. These are: make node locations coincident and maintain orbital density distribution. The first, make node locations coincident, requires both of the bonding orbitals (left and right) to have nodes in the same place. Otherwise, the orbitals would not be synchronous and the combined orbital would be discontinuous (and have infinite kinetic energy). According to the present disclosure, the process to synchronize a bonding orbital depends on the nature of the opposite bonding orbital. For example, if the right bonding orbital, ψᵣ, is a p_{z}, then the left bonding orbital, ψ₁, is made orthogonal to the right core, and transformed into ψ₁, by placing a node at the center of the right nucleus. Or, if the right bonding orbital, ψᵣ, is an s, then the left bonding orbital ψ₁, is made orthogonal to the right core, and transformed into ψ₁, by placing nodes at the position of the node in ψᵣ. The second, maintain orbital density distribution, notes that it is impossible to construct a ψ with exactly the same charge density as the corresponding ψ because this would require a discontinuity in the function at the node. However, this disclosure incorporates a procedure which derives a satisfactory approximation of a ψ. This invention utilizes the following procedure to approximate ψ.

An approximate, and normalized, ψ function is constructed which has a relatively gentle transition at the node. This approximation does not permit a displacement of charge density from one side of the nucleus to the other or cause a net displacement of charge toward, or away from, the nucleus. The bond energy is calculated for successively sharper node transitions. Alternatively, just the difference KE_{bond}−(KE_{ψ}_{_}−KE_{ψ}) could be calculated. Usually, as the transition becomes sharper, the bond energy will improve slowly, and the overlap change little. At some point the bond energy will decrease. The function that has the best energy is utilized. Sometimes, usually when one or both of the bonding atoms are “soft” (e.g., H, light elements), the bond energy does not improve as the node transition becomes sharper. In these cases the bond energy decreases slowly as the node transition sharpens. At some point the bond energy will begin to deteriorate more quickly for a given change in the node transition. The function just prior to the inflection point is chosen. Although the selection of the synchronous bonding orbital is sometimes not precise, the process does not appear to introduce an error of more than a few percent even in the worst cases.

There is a reason that the bond energy is relatively stable with changes in ψ. As the node transition sharpens, KE_{ψ} increases. The increase in KE_{ψ} is accompanied by a corresponding increase in KE_{ψl+r}. The difference between these two quantities, KEₙₑₜ, remains relatively constant.

Core Orthogonality Energy Penalty—Next, the method calculates the core orthogonality energy penalty. For two hybrid sigma bonding orbitals (comprised of the s and p_{z} atomic orbitals) of the form ψᵣ=fs_{br} s+fp_{br}p_{z} ((fs_{br} stands for fraction s bonding right) and ψ₁=fs_{br1}s+fp_{bl}p_{z}, this method calculates the energy to core orthogonalize the hybrid orbitals, KE_{core}_{_}ₒᵣₜₕₒ, as

KE_{core}_{_}ₒᵣₜₕₒ=(fs_{bl}·fs_{br}·fs_{bl}·fs_{br}·(KEₛ_{_}ₛₐₗ−KEₛₗ)+fs_{bl}·fs_{br}·fs_{bl}·fs_{br}·(KEₛ_{_}ₛₐₗ−KEₛᵣ)+fs_{bl}·fp_{br}·fs_{bl}·fp_{br}·(KEₛ_{_}_{pzal}−KEₛₗ)+fs_{bl}·fp_{br}·fs_{bl}·fp_{br}·(KE_{pz}_{_}ₛₐᵣ−KE_{pzr})+fp_{bl}·fs_{br}·fp_{bl}·fs_{br}·(KE_{pz}_{_}ₛₐₗ−KE_{pzl})+fp_{bl}·fs_{br}·fp_{bl}·fs_{br}·(KEₛ_{_}_{pzar}−KEₛᵣ)+fp_{bl}·fp_{br}·fp_{bl}·fp_{br}·(KE_{pz}_{_}_{pzal}−KE_{pzl})+fp_{bl}·fp_{br}·fp_{bl}·fp_{br}·(KE_{pz}_{_}_{pzar}−KE_{pzr}))

where KEₛₗ and KE_{pzl} are the kinetic energies of the left s and p_{z} initial atomic orbitals and KEₛᵣ and KE_{pzr} are those on the right. KEₛ_{_}ₛₐₗ is the kinetic energy of the s orbital on the left which has been synchronized with the right hand s (the subscript“a” indicates the orthogonalized, synchronized orbital.). KEₛ_{_}_{pzal} is the kinetic energy of the s orbital on the left which has been synchronized with the right hand p_{z}. KE_{pz}_{_}ₛₐₗ is kinetic energy of the p_{z} orbital on the left which has been synchronized with the right hand s. KE_{pz}_{_}ₚₐₗ is kinetic energy of the p_{z} orbital on the left which has been synchronized with the right hand p_{z}. The suffix r indicates the corresponding orbitals on the right. Naturally, KE_{core}_{_}ₒᵣₜₕₒ decreases the bond energy. As described above, KE_{core}_{_}ₒᵣₜₕₒ is incurred only to the extent of 1.0−fraction_bonding.

To the extent that a bond is bonding, a second sigma orbital may remain in place. This second sigma orbital may participate in dual bonding if there is a corresponding sigma orbital on the opposite atom, but it also must be made core orthogonal. According to the present disclosure, to the extent that it is not bonding, this second sigma orbital must be made orthogonal to the opposite atom's core electrons. The orthogonalization is performed in the same manner as described above and the energy calculated in the manner described above. The energy associated with this orthogonalization is designated KE_{core}_{_}ₒᵣₜₕₒ_{_}ₓ. Since, in general, this orthogonalization is different for each side, each side is calculated separately, so for the left,

KE_{core}_{_}ₒᵣₜₕₒ_{_}ₓ₁=(fs_{bl}·fs_{br}·fs_{bl}·fs_{br}·(KEₛ_{_}ₛₐₗ−KEₛₗ)+fs_{bl}·fp_{br}·fs_{bl}·fp_{br}·(KEₛ_{_}_{pzal}−KEₛₗ)+fp_{bl}·fs_{br}·fp_{bl}·fs_{br}·(KE_{pz}_{_}ₛₐₗ−KE_{pzl})+fp_{bl}·fp_{br}·fp_{b1}·fp_{br}·(KE_{pz}_{_}_{pzal}−KE_{pzl})).

The calculations for the right side are analogous to those on the left. Except when the second sigma electrons participate in parallel bonding, the second sigma electrons must be made orthogonal to the core electrons of the opposite atom to the extent that the bond is bonding. When reconfigured, these electrons are already orthogonal to the opposite core. So, except when parallel bonding, the KE_{core}_{_}ₒᵣₜₕₒ_{_}ₓ penalty is taken only to the extent of overall fraction_bonding, (usually) 0.5. If there are second sigma bonding orbitals on both sides of the bond and dual bonding occurs, then the KE_{core}_{_}ₒᵣₜₕₒ_{_}ₓ penalty is further reduced to the extent that the second set of sigma orbitals themselves bond. So, if the bonding of the second set of sigma orbitals is designated fraction_bonding_{second set} and the overall bonding is 0.5 then the net core orthogonalization penalty is 0.5·(1−fraction_bonding_{second set})·KE_{core}_{_}ₒᵣₜₕₒ_{_}ₓₗ.

For two and three coordinate atoms, the KE_{core}_{_}ₒᵣₜₕₒ_{_}ₓ penalty is reduced further. The penalty depends on the fraction that the second sigma orbital spends as s. On multi-coordinate atoms, the coordinate atoms drive s⇒p_{⊥} when they are not bonding. Also on multi-coordinates, because the coordinate atoms are all bonding at the same time, the bonding between the second set of sigma orbitals is reduced. For example, for the CC bond in HCCH, the core orthogonalization penalty for the left is 0.5·0.5·(1−0.5 fraction_bondingₛ₋ₛ)·KE_{core}_{_}ₒᵣₜₕₒ_{_}ₓₗ. The second 0.5 factor arises because the coordinate HC bond drives s⇒p_{⊥} when it is not bonding. The 0.5 arises because the coordinate HC bond on the opposite C drives s⇒p_{⊥} when it is not bonding, limiting the s_s bonding.

For the CC bond in H₂CCH₂, the core orthogonalization penalty for the left is 0.25·0.5·(1−0.25·fraction_bondingₛ₋ₛ)·KE_{core}_{_}ₒᵣₜₕₒ_{_}ₓₗ. The 0.25 factor arises because the two coordinate HC bonds drive s⇒p_{⊥} when they are not bonding. The 0.25 arises because the coordinate HC bonds on the opposite C drive s⇒p_{⊥} when they are not bonding.

In the case where the second sigma electrons do not participate in bonding, the orbitals do not need to be synchronized, and, according to the present disclosure, the most energy favorable orthogonalization method can be utilized. Not all bonds have a second set of sigma orbitals on both sides (HB, HC, HN, HO, for example). If the extra electrons do not participate in bonding then the above becomes

KE_{core}_{_}ₒᵣₜₕₒ_{_}ₓₗ=(fs_{bl}·fs_{bl}(KEₛ_{_}ₛₐₗ−KEₛₗ)+fp_{bl}·fp_{bl}·(KE_{pz}_{_}ₛₐₗ−KE_{pzl})). or

KE_{core}_{_}ₒᵣₜₕₒ_{_}ₓₗ=fs_{bl}·fs_{bl}·(KEₛ_{_}_{pzal}−KEₛₗ)+fp_{bl}·fp_{bl}·(KE_{pz}_{_}_{pzal}−KE_{pzl})). or

KE_{core}_{_}ₒᵣₜₕₒ_{_}ₓₗ=fs_{bl}·fs_{bl}(KEₛ_{_}ₛₐₗ−KEₛₗ)·fp_{bl}·fp_{bl}·(KE_{pz}_{_}_{pzal}−KE_{pzl})). or

KE_{core}_{_}ₒᵣₜₕₒ_{_}ₓₗ=fs_{bl}·fs_{bl}(KEₛ_{_}_{pzal}−KEₛₗ)+fp_{bl}·fp_{bl}·(KE_{pz}_{_}ₛₐₗ−KE_{pzl})).

The expression that gives the best energy is chosen. Generally, there is not a large difference among these options.

Calculate Sigma Overlap/Fraction_Bonding/Kinetic Energy—For a single set of hybrid sigma bonding orbitals of the form ψᵣ=fs_{br}s+fp_{br}p_{z} and ψ₁=fs_{brl} s+fp_{bl} pz, according to the present method, the quantities overlap and KE_{bond} are:

overlap=fs_{bl}·fs_{br}·overlapₛ₋ₛ+fp_{bl}+fp_{br}·overlap_{pz-pz}+fp_{bl}·fs_{br}·overlap_{pz-s}+fs_{bl}·fp_{br}·overlap_{s-pz}

KE_{bond}=(1.0/(1.0+overlap))·(fs_{bl}·fs_{bl}·overlapₛ₋ₛ·KE_{net s-s}+fp_{bl}·fp_{br}·overlap_{pz-pz}·KE_{net pz-pz}+fp_{bl}·fs_{br}·overlap_{pz-s}·KE_{net pz-s}+fs_{bl}·fp_{br}·overlap_{s-pz}·KE_{net s-pz}).

Dual bonding changes the above calculation of overlap and KE_{bond} somewhat. Consider two atoms each with a sigma bonding configuration of 2s²2p (e.g. N₂). The bond between these atoms could be considered as an sp-sp hybrid bond and an s-s bond with each weighted by 0.5. Alternatively, the bond between these atoms could be considered as an sp-sp hybrid bond, an s-s bond, an sp-s bond and an s-sp bond with each weighted by 0.25. According to the present method, in the latter case (s²p_{z} on both sides), the relevant quantities are:

fraction_bondingₛ₋ₛ=overlapₛ_{_}ₛ/(1.0+overlapₛ_{_}ₛ)

fraction_bondingₛ₋ₛₚ=overlapₛ_{_}ₛₚ/(1.0+overlapₛ_{_}ₛₚ)

fraction_bondingₛₚ₋ₛ=overlapₛₚ_{_}ₛ/(1.0+overlapₛₚ_{_}ₛ)

fraction_bondingₛₚ₋ₛₚ=overlapₛₚ_{_}ₛₚ/(1.0+overlapₛₚ_{_}ₛₚ)

fraction_bondingₐᵥₑ=0.25·(fraction_bondingₛ₋ₛ+fraction_bondingₛ₋ₛₚ+fraction_bondingₛₚ₋ₛ+fraction_bondingₛₚ₋ₛₚ)

overlapₐᵥₑ=fraction_bondingₐᵥₑ/(1.0−fraction_bondingₐᵥₑ)

simultaneous_bond_{s-s/sp-sp}=fraction_bondingₛ₋ₛ·fraction_bondingₛₚ₋ₛₚ

simultaneous_bond_{s-sp/sp-s}=fraction_bondingₛ₋ₛₚ·fraction_bondingₛₚ₋ₛ

overlap_{s-s/sp-sp}=simultaneous_bond_{s-s/sp-sp}/(1.0−simultaneous_bond_{s-s/sp-sp})

overlap_{s-sp/sp-s}=simultaneous_bond_{s-sp/sp-s/}(1.0−simultaneous_bond_{s-sp/sp-s})

overlap=2 overlapₐᵥₑ−overlap_{sp-s/s-sp}−overlap_{s-sp/sp-s}

fraction_bonding=overlap/(1.0+overlap)

factor=fraction_bonding/fraction_bondingₐᵥₑ

KE_{bond}=factor·0.25(KE_{bond s-s}+KE_{bond s-sp}+KE_{bond sp-s}+KE_{bond sp-sp})

With the N₂ bonding configurations, both sides 2s²2p_{z}, the dual bond overlap is actually somewhat less than the overlap of the sp-sp overlap alone. This is because the s-s overlap is much less than the sp-sp overlap.

Consider two atoms each with a sigma bonding configuration of 2s²2p_{z}² (e.g. O₂). According to the present method, in this case the relevant quantities are:

fraction_bondingₛₚ₋ₛₚ=overlapₛₚ_{_}ₛₚ/(1.0+overlapₛₚ_{_}ₛₚ)

fraction_bondingₐᵥₑ=fraction_bondingₛₚ₋ₛₚ

overlapₐᵥₑ=fraction_bondingₐᵥₑ/(1.0−fraction_bondingₐᵥₑ)

simultaneous_bond_{sp-sp/sp-sp}=fraction_bondingₛₚ₋ₛₚ·fraction_bondingₛₚ₋ₛₚ

overlap_{sp-sp/sp-sp}=simultaneous_bond_{sp-sp/sp-sp/}(1.0−simultaneous_bond_{sp-sp/sp-sp})

overlap=2·overlapₐᵥₑ−2·overlap_{sp-sp/sp-sp}

fraction_bonding=overlap/(1.0+overlap)

factor=fraction_bonding/fraction_bondingₐᵥₑ

KE_{bond}=factor·KE_{bond sp-sp}

With these bonding configurations, both 2s²2p_{z}², the dual bond overlap is somewhat more than the overlap of the sp-sp overlap alone.

Consider two atoms, one with a sigma bonding configuration of 2s²2p_{z} and one with a sigma bonding configuration of 2s²2p_{z}² (e.g. NO). According to the present method, in this case the relevant quantities are:

fraction_bondingₛ₋ₛₚ=overlap_{s sp}/(1.0+overlapₛ_{_}ₛₚ)

fraction_bondingₛₚ₋ₛₚ=overlapₛₚ_{_}ₛₚ/(1.0+overlapₛₚ₋ₛₚ)

fraction_bondingₐᵥₑ=0.5·(fraction_bondingₛ₋ₛₚ+fraction_bondingₛₚ₋ₛₚ)

overlapₐᵥₑ=fraction_bondingₐᵥₑ/(1.0−fraction_bondingₐᵥₑ)

simultaneous_bond_{s-sp/sp-sp}=fraction_bondingₛ₋ₛₚ·fraction_bondingₛₚ₋ₛₚ

overlap_{s-sp/p-sp}=simultaneous_bond_{s-sp/sp-sp/}(1.0−simultaneous_bond_{s-sp/sp-sp})

overlap=2·overlapₐᵥₑ−2·overlap_{s-sp/sp-sp}

fraction_bonding=overlap/(1.0+overlap)

factor=fraction_bonding/fraction_bondingₐᵥₑ

KE_{bond}=factor·0.5·(KE_{bond s-sp}+KE_{bond sp-sp})

Impact of the Dual Bonding of Residual s Orbitals on Overlap—As mentioned in the section on electronic configurations above, according to the present method, unsaturated compounds can have s orbitals which are not completely promoted to p_{⊥}. The C in the molecule of the form X₂CCX₂ has residual s to the extent that all three of its bonds are bonding (i.e. 0.5.0.5.0.5). The residual s is available for sigma bonding to the extent that the opposite bonds are bonding (i.e. 0.5.0.5). The C in a molecule of the form XCCX has residual C to the extent that each of its bonds are bonding (i.e. 0.5.0.5) and these are available for bonding to the extent that the opposite is bonding (i.e. 0.5). According to the present method, molecules of this type form dual sigma bonds to the extent that both central atoms have residual s available for bonding. So, a molecule of the form X₂CCX₂ has a dual sigma bond to the extent of 0.25·0.25. Similarly a molecule of the form XCCX has a dual bond to the extent of 0.5.0.5.

Should there be adjacent unsaturated atoms then, according to the present method, the residual s is “shared” in a manner similar to the sharing of p orbitals described below. For example, the Cs in benzene have s which is “shared” between two CC bonds. Each of the bonding s are “shared” so that the dual bonding is reduced by a factor of (1.0−fraction_bondingₛ₋ₛ) (1.0−fraction_bondingₛ₋ₛ). There is a dual sp-sp and s-s bond in benzene to the extent of 0.25·0.25 (1.0−fraction_bondingₛ₋ₛ)·(1.0−fraction_bondingₛ₋ₛ). These are not large effects, but they are not insignificant.

Impact of Parallel Bonding on Fraction_Bonding Parallel—bonding is a type of dual bonding that occurs when, instead of reconfiguring to orthogonalize, the second sigma orbital forms a node to make it orthogonal to the opposite side bonding orbital. The best example of this bonding is F₂. F has a bonding configuration of 1s²2s²2p_{z}²2p_{xy}³. For parallel bonding, according to the present invention, fraction_bonding is simply the sum of fraction_bonding for each of the two sigma bonds. So for the parallel bond: fraction_bonding=fraction_bondingₛₚ₋ₛₚ+fraction_bondingₛₚ₋ₛₚ and KE_{bond}=KE_{bond sp-sp}+KE_{bond sp-sp}.

Since fraction_bonding calculated in this manner is subject to the usual constraint (maximum of 0.5) parallel bonding results in relatively long bond lengths. Two factors drive F₂ to this parallel bonding. F₂ exhibits pi resonance [F+F−, FF, F−F+]. Reconfiguration orthogonalization is not possible for F−since there is no “hole” in which to place the opposing orbital. The second factor that favors parallel bonding here is pi orthogonalization (overlapping pi orbitals containing electron pairs need to be orthogonalized just like sigma orbitals.). Retaining two electrons in the 2p_{z} orbital lengthens the bond, thereby minimizing the impact of pi orthogonalization.

According to the present disclosure, the orthogonalization required when the second sigma electron remains in place is similar to the core orthogonalization described above except that the second bonding orbital must be made orthogonal to the opposite bonding orbital rather than the opposite core electron. When parallel bonding the second set of bonding orbitals do not need to be synchronous. This invention performs this orthogonalization using a single node whose position is varied to obtain the most favorable energy. The procedure maintains the atomic orbital density distribution in a manner similar to that described above with respect to core orthogonalization.

Calculate Pi Bonding—Analogous to sigma bonding, according to the present invention: fraction_bonding_{π}=overlap/(1.0+overlap_{π}). KE_{bond}_{_}_{π}=fraction_bonding_{π}·KEₙₑₜ_{_}_{π}, where KEₙₑₜ_{_}_{π}=KE_{combined}_{_}_{π}−KE_{π}_{_}₁, KE_{π}_{_}ᵣ. Pi overlaps are much smaller than sigma overlaps, usually in the range of 0.1 to 0.3. Because full pi resonance implies fraction_bonding_{π}=0.5, pi resonance has a much bigger impact on the bond energy than a simple pi bond. Pi resonance is relatively common.

Pi Bonding Probability in Poly-Atomics—According to the present disclosure, pi bonding only occurs to the extent that both pi bonding orbitals have the appropriate symmetry. For example, consider a molecule for the form X₂CCX₂, where C is carbon and assume no pi resonance. There is a p electron on each C to the extent that any one of the three coordinate C bonds is not bonding (1.0−0.5·0.5·0.5)=0.875. Since there must be a p electron on each C for bonding, according to the present method, the probability of pi bonding here is 0.875·0.875=0.765625.

Consider a hypothetical molecule XCCX where C is carbon and assume no pi resonance. This method determines the pi bonding as follows. If each C has a single p electron (s [symbol] p_{π}÷ there is one pi bond. If one C has one p electron and the other C two (s [symbol] p_{π} on one side and sp on the other), there are 2^{1/2} [2·(0.5)^{1/2}] pi bonds. Two pi bonds form when both C have two p electrons (when s⇒p_{π} on both sides).

Pi Orthogonalization—When the p_{π} orbitals on the atom on one side of the bond are more than half full (three or four electrons) and the p_{π} orbitals on the other side are at least half full, then, according to the present disclosure, one of each of the spin paired pi orbitals must be made orthogonal to the pi bonding orbitals from the opposite side. This orthogonalization is analogous to the “orthogonalization via node formation” described above with respect to sigma bonding, with a node placed in the p_{π} orbital to make it orthogonal to the opposite pi bonding orbital. This method utilizes an analytical procedure, similar to the one used for core orthogonalization described above, to find the optimal node position and node transition. As in core orthogonalization, this method attempts to maintain the atomic orbital density distribution as closely as possible. Analogous to sigma bonding, the pi orthogonalization penalty is taken only to the extent of (1.0−fraction_bonding_{π}).

Pi Orbital Sharing—In numerous poly-atomics, such as benzene (C₆H₆) and graphite (—C₂CC₂—) a single p_{π} orbital is shared between two or more pi bonds. According to the present method, the shared pi bonding is reduced from the single pi bond in a manner consistent with the manner that secondary sigma bonds are reduced by the primary sigma bond (to be described below). For example, if a single p_{π} orbital is shared between two pi bonds, fraction_bondingₙₑₜ_{_}_{π}=(1.0−fraction_bonding_{π})·fraction_bonding_{π} and the energy associated with each of the bonds would be (1.0−fraction_bondingₙₑₜ_{_}_{π})·KE_{π}. Usually p sharing is more complex. Consider benzene. The p_{π} orbital on each C is present only when s⇒p_{π}^{≈} Each p_{π} is shared by two bonds. If we take the fraction s⇒p_{π} as fpup (fpup stands for fraction p ta) (fpup is 0.875 here) then the net pi bond for benzene (ignoring the partial pi resonance) is fraction_bondingₙₑₜ_{_}_{π}=fpup·fpup·(1.0−fpup·fraction_bonding) (1.0−fpup·fraction_bonding_{π})·fraction_bonding.

Calculate Secondary/Tertiary Interactions—A final step in the method as disclosed herein is to calculate secondary/tertiary interactions. According to the present disclosure, secondary/tertiary bonding differs from primary bonding in three ways. First, the quantization of the primary is retained in the secondary, tertiary, etc. In other words, the orientation of the directional (e.g. 2p) orbitals in the primary bond is retained in the subsequent bonds. Secondly, secondary bonding is reduced by the extent of primary bonding (and the tertiary by the extent of primary and secondary and etc.) if both of the secondary (and the tertiary, etc.) bonding orbitals were also involved in primary bonding. The reduction in secondary bonding, by primary bonding, is determined by the least primary bonding of the two secondary bonding orbitals. Thirdly, total overlap, including contributions from secondary and subsequent bonds, is calculated along principle axis of quantization which is usually the primary bond axis. However, metals have no primary bond axis. In metals, the total bond overlap is calculated along the Cartesian axes.

According to the present disclosure, the secondary (tertiary, etc.) overlap between the primary bonding orbital on the left and the secondary bonding orbital on the right is as follows:

overlap_{sec}_{_}₁=fs_{bl}·fs_{br}·overlapₛ₋ₛ+cos θₗ·cos θᵣ·fp_{bl}·fp_{br}·overlap_{pz-pz}+cos θₗ·fp_{bl}·fs_{br}·overlap_{pz-s}+cos θᵣ·fs_{bl}·fp_{br}·overlap_{s-pz}

where θₗ is the angle between the primary axis of quantization of the left atom and the secondary (tertiary, etc.) bond axis and where θᵣ is the angle between the primary axis of quantization of the right atom and the secondary (tertiary, etc.) bond axis. Notice that fs_{bl} and fp_{bl} refer to the hybridization of the primary orbital on the left and fs_{br} and fp_{br} refer to the hybridization of the secondary orbital on the right. Note also that, in general, the secondary for the left is different from the secondary on the right. The calculation of overlap_{sec}_{_}ᵣ is analogous to that on the left. Sometimes there is a secondary on one side but none on the other (e.g. CH₄, CF₄). According to the present disclosure, if a secondary atom is not quantized, the overlap contribution changes. If, for example, the right secondary atom were F, which is not quantized, then:

overlap_{sec}_{_}₁=fs_{bl}·fs_{br}·overlapₛ₋ₛ+cos θₗ·fp_{bl}·fp_{br}·overlap_{pz-pz}+cos θₗ·fp_{bl}·fs_{br}·overlap_{pz-s}+fs_{bl}·fp_{br}·overlap_{s-pz}.

According to the present disclosure, the overlap component along the primary bond axis, overlap_{sec}_{_}ₗ_{_}_{z}, is: overlap_{sec}_{_}ₗ_{_}_{z}=cos² θ·overlap_{sec}_{_}₁ where θ is the angle between the primary bond axis and the secondary (tertiary, etc.) bond axis. According to the present disclosure, secondary fraction_bonding increment, fraction_bonding_{sec}_{_}ₗ_{_}_{inc}, is: fraction_bonding_{sec}_{_}ₗ_{_}_{Inc}=0.5·(1−fraction_bondingₗₑₛₛₒᵣ_{_}_{primary}_{_}₁)·(overlap_{sec}_{_}ₗ_{_}_{z}/(1+overlap_{sec}_{_}ₗ_{_}_{z})) where fraction_bondingₗₑₛₛₒᵣ_{_}_{primary}_{_}₁ is the lessor of the two fraction_bonding_{primary} associated with the secondary. The factor of 0.5 arises in the equation above because the calculation is for one of the two sides.

According to the present method, the contribution of the secondary overlap to the total overlap, the secondary overlap increment, overlap_{sec}_{_}ₗ_{_}_{inc}, is: overlap_{sec}_{_}ₗ_{_}_{inc}=fraction_bonding_{sec}_{_}ₗ_{_}ᵢₙ/(1−fraction_bonding_{sec}_{_}ₗ_{_}_{inc}). The calculations for the right side are analogous to those on the left. The overlap subtotal, overlap_{subtotal}, is overlap_{subtotal}=overlap_{primary}+overlap_{sec}_{_}ₗ_{_}_{inc}+overlap_{sec}_{_}ᵣ_{_}_{inc}, and fraction_bonding_{subtotal}=overlap_{subtotal}/(1+overlap_{subtotal}).

Subsequent, secondary (or tertiary and etc.) bonds are treated similarly. For example, for a second secondary with the overlap, overlap fraction_bonding sec₂_{_}ₗ_{_}_{z}, sec₂_{_}ₗ_{_}_{inc}=(1−fraction_bondingₗₑₛₛₒᵣ_{_}_{subtotal})·(overlap_{sec2}_{_}ₗ_{_}_{z}/(1+overlap_{sec2}_{_}ₗ_{_}_{z})), overlap_{sec2}_{_}ₗ_{_}_{inc}=fraction_bonding_{sec2}_{_}ₗ_{_}_{inc}/(1−fraction_bonding_{sec2}_{_}ₗ_{_}_{inc}). The overlap subtotal, overlap_{subtotal}, is overlap_{subtotal}=overlap_{primary}+overlap_{sec}_{_}ₗ_{_}_{inc}+overlap_{sec}_{_}ᵣ_{_}_{inc}+overlap_{sec2}_{_}ᵣ_{_}_{inc}+overlap_{sec2}_{_}ₗ_{_}_{inc}, and fraction_bonding_{subtotal}=overlap_{subtotal}/(1+overlap_{subtotal}).

Summing overlap contributions in this manner is very important because they make up a very significant portion of the total overlap (typically around 10-25%) and therefore have a very large impact on the bond length and, indirectly, via the overlapₜₒₜₐₗ=1 constraint, on the bond energy. The direct secondary contributions to the bond energy (described below) can sometimes be ignored for an approximate result but the secondary contributions to overlap cannot be ignored.

According to the present disclosure, secondary bonds are reduced only to the extent of the primary bonding of the lessor of the two primary bonds associated with the secondary. Consider, for example, H₂CO. The O has two orbitals with symmetry appropriate for sigma bonding. Only one of these is involved in the primary CO sigma bonding. The other is primary non-bonding. The H O secondary bonds, which are between the bonding H sigma and the non-bonding O orbital, are not reduced by primary bonding. Another interesting example is the secondary bonding in CF₄. Here the Fs have one primary bonding orbital and one non-bonding. Between each pair of Fs there are two secondary bonds neither of which is reduced by the primary CF bond.

According to the present disclosure, secondary bonds can be parallel. Secondary bonds are parallel under the same conditions as are primary bonds. For example consider CF₄. CF₄ has a resonance of the form [C+F₃F—]₃[CF₄]. One of the two F to F— secondary bonds must be parallel as F— cannot reconfigure to orthogonalize. (This parallel bond is in addition to the secondary parallel bonds associated with secondary sigma resonance.)

Secondary, Tertiary, etc. Core Orthogonalization—According to the present disclosure, the energy associated with the overlap of the primary bonding orbital on the left and the core electrons of the secondary atom on the right is as follows:

KE_{core}_{_}ₒᵣₜₕₒ_{_}_{sec}_{_}₁=(fs_{bl}·fs_{br}·fs_{bl}·fs_{br}·(KEₛ_{_}ₛₐₗ−KEₛₗ)+fs_{bl}·fp_{br}·fs_{bl}·fp_{br}·(KEₛ_{_}_{pzal}−KEₛₗ)+cos(θ)·fp_{bl}·fs_{br}·fp_{bl}·fs_{br}·(KE_{pz}_{_}ₛₐₗ−KE_{pzl})+cos(θ)·fp_{bl}·fp_{br}·fp_{bl}·fp_{br}·(KE_{pz}_{_}_{pzal}−KE_{pzl})).

The calculations for the right side are analogous to those on the left. The _{core}_{_}ₒᵣₜₕ contributions are taken only to the extent of (1−fraction_bondingₜₒₜₐₗ). In polyatomic molecules, fraction_bondingₜₒₜₐₗ reaches 0.5. The KE_{core}_{_}ₒᵣₜₕ_{_}_{sec} contributions to the bond energy are generally quite small.

Secondary, Tertiary, etc. Potential Energy—These terms are calculated in the same manner as those of the primary terms. The secondary, tertiary and etc. contributions are much smaller than the primary due to the larger atomic distances, but they are nonetheless usually significant.

The following paragraphs discuss four subjects which require further elaboration: The Impact of Sigma Resonance on Fraction_Bonding, The Calculation of Bond Angles, Bonding in Metals and Intermolecular Bonding.

Impact of Sigma Resonance on Fraction_Bonding—According to the present method, resonance can impact fraction_bonding in two different ways. When there are two sigma electrons on the anionic atom of the resonance and the resonance electron transfer is unambiguously sigma to sigma, parallel bonding to the extent of 0.5 is introduced. Alternatively, when there are two sigma electrons on the anionic atom and the resonance electronic transfer is not unambiguously sigma to sigma (such as when the transfer could be pi to pi followed by a p_{π}⇒p_{z} reconfiguration), the character of the orbital overlap is changed. For example, when the atoms are nominally dual bonded sp sp and s-s, the ambiguous sigma to sigma transfer causes the overlaps to be one half sp-sp and s-sp and one half sp-sp and s-s.

Sigma resonance typically involves “one-sided orthogonalization”. According to the present method, a one-sided orthogonalization entails no orthogonalization on one side of a bond and 2 times orthogonalization on the other (i.e. no orthogonalization on one side and total orthogonalization on the other side). For example, consider the [H+F−, HF, H—F+] resonance. The F− does not orthogonalize as there is total orthogonalization on the opposite H+ side (H+ has no electrons to orthogonalize.). H− does not orthogonalize, but F+ orthogonalizes by forming two, rather than just one, opposing orbitals.

The [H+F−, HF, H−F+] resonance entails partial parallel bonding. Consider the H+ and the F− in the [H+F−, HF] sigma resonance separately. From the perspective of F−, there are two parallel sigma sp-s bonds. From the perspective of H+ there is a single s-sp bond. Each side is weighted by 0.5, so according to the present method, the net impact is to create 1.5 bonds. The quantity, fraction_bonding is increased by 50%. Consider the H− and the F+ in the [H−F+, HF] resonance. From the perspective of H−, there are two parallel sigma bonds, an s-sp and an s-s (The F+ not bonding configuration is 2spₒ2s2p_{z}2p_{xy}³.). From the perspective of F+ there are dual s-sp bonds. For this [H−F+, HF] portion of the full resonance, this method considers that fraction_bonding is also increased by a partial parallel bond. The HO, HN, HC and HB resonances exhibit similar effects.

According to the present disclosure, sigma resonance has a similar impact in poly-atomics. CF₄ has a sigma resonance of the form [C+F₃F−]₃[CF₄] with each F taking on a negative charge for 0.2. The C+ is orthogonal to the F−. To the extent that each F is F−, (i.e. 0.2) there is an extra 0.5 parallel bond. BF₃ is similar. BF₃ has a sigma resonance of the form [B+F₂F−]₂[BF₃] with each F taking on a negative charge for 0.25. To the extent that each F is F− in BF₃, (i.e. 0.25) there is an extra 0.5 parallel bond. According to the present disclosure, the parallel bonding associated with sigma resonance is proportional to the time spent as an anion (usually F−).

In the CF sigma resonance [CF,C+F−] the relative populations are [0.75,0.25]. There are parallel sp-sp and s-sp bonds for 0.5.0.25 (the C bonding configuration is 2s²2p_{z}2p_{xy}, the C not bonding configuration is 2spₒ2 s2p_{z}2p_{xy}, the C+ configuration is 2spₒ2 s2p_{xy}). There is a dual sp-sp and s-sp bond for 0.75 and for 0.5.0.25 (i.e. the residual of the time spent as C+F−).

In some embodiments, there can be secondary parallel bonding associated with secondary sigma resonance. For example, there is a secondary F− to F [F−,F₃] resonance in CF₄. This sigma resonance makes a significant parallel bond contribution. There is no secondary parallel bonding associated with the secondary F− to F resonance in BF₃ as BF₃ is planar and the secondary resonance is a pi resonance.

According to the present method, not all occurrences of “one-sided orthogonalization” result in a parallel bond contribution to the overall fraction_bonding. For example, BO exhibits a [BO,B+O−] resonance. Here B has the bonding configuration 2s²2p_{xy} and the not-bonding configuration 2spₒ2 s2p_{xy}. The configuration of B+, is 2spₒ2 s. The O− to B+ resonance electron transfer is a direct transfer from an O− pi orbital to a B+pi orbital. There is no parallel sigma bond contribution in BO. There can be a parallel bond contribution to the fraction_bonding when there is no “one-sided orthogonalization”. This occurs in BO₂. BO₂ exhibits a resonance [O⁻B⁺O,OBO,OB⁺O⁻] with [O⁻B⁺O]=0.333. When either side is not bonding (0.75), B is 2s2p_{z}2p and B⁺ is 2s2p_{z}. When both sides are bonding B is 2s²2p_{z} and B⁺ is 2s². This is a pi resonance most of the time but a sigma resonance when both sides are bonding (s [symbol] p_{π}^{÷≈}ℑ» the extent that s [symbol] p_{π}) BO₂ exhibits a parallel bond contribution to fraction_bonding.

According to the present method, those resonances where the anionic to cationic electron transfer could be either sigma or pi, not simply sigma, have a different impact on fraction_bonding from those with an unambiguous sigma to sigma transfer. Here the dual sigma bonding overlaps are altered to reflect the passage of a p_{z} from the anionic to cationic atom. For example, consider O₂⁺. O has the bonding configuration 2s²2p_{z}²2p_{π}². O⁺ has the bonding configuration 2s²2p_{z}2p². The dual sigma bond overlaps here are half sp-sp and sp-s and half sp-sp and sp-sp. Were there no resonance the dual bond overlaps here would be sp-sp and sp-s.

Consider N₂⁺. N has the bonding configuration 2s²2p_{z}2p². N⁺ has the bonding configuration 2s²2p_{z}2p. Although the resonance here, [N+N,NN+], is nominally a pi resonance, it is possible that there is an sp to sp sigma transfer with the p_{z} reconfiguring to p_{π}. Were there no resonance N₂⁺ would exhibit a dual sp-sp and s-s overlap. The possibility of partial sigma resonance causes the dual bond to be a combination of half sp-sp and s-s overlaps and half sp-sp and s-sp overlaps. The [BO,B+O−] resonance discussed above causes a similar alteration in the BO dual sigma bond due to the possibility of an sp to sp transfer from O− to B+ followed by the p_{z} reconfiguring to p. The C+O− dual sigma bond in the [C−O+,CO,C+O−] pi resonance is similarly impacted by resonance.

Calculation of Bond Angles—The angle between ligands, or between a ligand and a nonbonding electron or electron pair, is a function of the sharing the Carteasian axes between the sigma bonds, or between a sigma bond and a nonbonding electron or pair of electrons. According to the present disclosure, the bond angle is the arccosine (a cos) of (−fraction of axis common to a bond and the opposing bond/lone pair). For example, consider the bonding in molecules with tetrahedral or pseudo tetrahedral central atoms such as CH₄, HN₃ or H₂O. Since these compounds make four bonds/lone pairs in the three Cartesian directions, only 0.75 of each axis can be allocated uniquely to each of the bonds/lone pairs. The remaining 0.25 must be common to the bond and opposite bonds. For a (pseudo)tetrahedral molecule the nominal bond (or bond/pair) angle=arcos(−0.25/0.75)=109.47°. For the trigonal case (BF₃,CH₃, etc.), three bonds share two axes. For a (pseudo)trigonal molecule the nominal bond (or bond/pair) angle=arcos(−0.333/0.667)=120°.

According to the present method, bond angles in poly-atomics with lone pairs deviate from the nominal to the extent that fsₒ·fsₒ or fpₒ·fpₒ of the opposing orbital is different from 0.5. For central atoms where fpₒ·fpₒ<fsₒ·fsₒ, the angle between the bond axis and the lone pair axis directly follows the reduced p character of the lone pair. For example, consider a hypothetical molecule AB₃ with A having a single lone pair. AB₃ has a pseudo tetrahedral structure similar to NH₃. The angle between the BA axis and the lone pair axis (the C₃ axis of the molecule) is given by C₃ angle=arccosine ((1.0−3.0·fpₒ·fpₒ·0.5)/(1.0−fpₒ·fpₒ·0.5)). The factor 0.5 arises because fraction_bonding=0.5. An example of this is NF₃.

Consider a pseudo-trigonal molecule where fpₒ·fpₒ<fsₒ·fsₒ like NO₂−. NO₂− is pseudo trigonal with a p orbital above the NON plane. According to the present invention, the angle between the ON axis and the lone pair axis (the C₂ axis of the molecule) is given by C₂ angle=arccosine ((1.0−2.0·fpₒ·fpₒ·0.5·1.33333)/(1.0−fpₒ·fpₒ·0.5·1.33333)). The factor 1.33333 arises because, an “extra” 1/3p character has to be added to the opposing orbitals to orthogonalize them. (The orbitals in a trigonal or pseudo trigonal structure are nominally sp² not sp³.) A second order correction needs to be applied to account for the increase in angle from the nominal 120 degrees) (cosine(120°=0.5), cosine(C₂ angle_{2nd order}) (cosine(C₂ angle)−0.5)·(0.5/cosine(C₂ angle))·(0.5/cosine(C₂ angle))+0.5.

According to the present method, for central atoms where fpₒ·fpₒ>fsₒ·fsₒ orthogonalization is achieved by bending the bond axes relative to the electronic axes. For example, consider a hypothetical pseudo-tetrahedral molecule AB₃ with A having a single lone pair. According to the present method, the angle between the BA axis and the lone pair axis in such a molecule is given by C₃ angle=arccosine ((((fpₒ·fp₀/0.5)−1.0)·0.33333+1.0)·0.33333). Recall that the nominal tetrahedral angle is 109.47° and that cosine)(109.47°=0.33333. An example of this is NH₃. As another example where fpₒ·fpₒ>fsₒ·fsₒ, consider a hypothetical pseudo-tetrahedral molecule AB₂ with A having two lone pairs. AB₂ is similar to AB₃ described above, but with somewhat more complex solid trigonometry. According to the present method, the BAB bond angle is given by BAB angle=2.0·arccosine ((((fpₒ·fp₀/0.5)−1.0)·0.5·0.33333·(0.5/0.57735)+1.0)·0.57735). The nominal tetrahedral angle is 109.47°. [cosine(109.47/2)°=0.57735·cosine(120/2)°=0.5.] An example of this is H₂O.

Bonding in Metals—Turning now to metals, according to the present method, bonding in metals differs from nonmetals in the following two ways. First, because there is no obvious primary, secondary, etc. axes in a metal, the overlap is calculated along the metal axes. Second, because there no primary bond which has precedence over others, each contribution to fractbnd_bonding is reduced by (1.0−fraction_bondingₜₒₜₐₗ). At the optimum, fraction_bondingₜₒₜₐₗ is, of course, 0.5.

In one embodiment, consider a metal with nₙₑₐᵣₑₛₜ nearest neighbors, which are at a angle of θₙₑₐᵣₑₛₜ from a major axis, with a overlap with the nearest neighbors of overlapₙₑₐᵣₑₛₜ. According to the present method, the fraction_bonding contribution from the nearest neighbors is fraction_bondingₙₑₐᵣₑₛₜ=(1.0−0.5)·(cosine²(θₙₑₐᵣₑₛₜ)·overlapₙₑₐᵣₑₛₜ/(1.0+cosine²(θₙₑₐᵣₑₛₜ)·overlapₙₑₐᵣₑₛₜ)), and its contribution to the overall overlap along the axis is overlapₐₓᵢₛ_{_}ₙₑₐᵣₑₛₜ=nₙₑₐᵣₑₛₜ·fraction_bondingₙₑₐᵣₑₛₜ/(1.0−fractbndₙₑₐᵣₑₛₜ) and fraction_bondingₙₑₐᵣₑₛₜ along the axis is fraction_bondingₐₓᵢₛ_{_}ₙₑₐᵣₑₛₜ=overlapₐₓᵢₛ_{_}ₙₑₐᵣₑₛₜ/(1.0+overlapₐₓᵢₛ_{_}ₙₑₐᵣₑₛₜ). The KE_{bond} contribution from the nearest neighbors is given as KE_{bond}_{_}ₙₑₐᵣₑₛₜ=fraction_bondingₐₓᵢₛ_{_}ₙₑₐᵣₑₛₜ·KEₙₑₜ. If the other Cartesian axes are similar then the total kinetic energy reduction for the nearest neighbor interactions is 3 times 2·KE_{bond}_{_}ₙₑₐᵣₑₛₜ. Calculations for the next-nearest neighbors and the next-next-nearest neighbors and etc. is analogous to that above. According to the present method, the overlapₐₓᵢₛ and KE_{bond} contributions are summed until the increment is insignificant. The potential energy contribution associated with the nearest neighbors, next-nearest neighbors, the next-next-nearest neighbors and etc. is calculated in the usual manner. The energy associated with a single atom-to-atom interaction is divided by two to obtain a single atom's contribution. The contributions to the orthogonalization penalty, KE_{core}_{_}ₒᵣₜₕₒ are also calculated in the usual manner. Each of these are reduced by (1.0−0.5). The quantity, 0.5, being the ultimate value for total fraction_bonding.

For metals with a single s valence configuration, such as lithium, overlapₙₑₐᵣₑₛₜ overlapₛ₋ₛ. Metals with a s² configuration, such as berillium, must promote one of the two s electrons to p in order to meet othogonality requirements. This causes there to be an sp hybrid along one of the Cartesian axes. In this case overlapₙₑₐᵣₑₛₜ=((2/3)·(2/3)·overlap₂ₛ₋₂ₛ+(1/3)·(1/3)·overlap₂ₛₚ₋₂ₛₚ+(2/3)·(1/3)·overlap₂ₛ₋₂ₛₚ+(1/3)·(2/3)·overlap₂ₛₚ₋₂ₛ).

According to the present method, electrical conductivity, in the absence of vibrational or other distortions, is subject to two factors, 1) the passage of electrons between atoms and 2) the passage of electrons through the atom. To the extent that the bonding orbital on one side of a metal atom is orthogonal to the equivalent bonding orbital on the opposite side, the passage of electrons will be restricted. Metal atoms that have single s configurations bond to both sides with the same orbital. There is no barrier to the passage of an electron. Metal atoms that have s² configurations must promote one of the s to p in the solid and create mutually orthogonal sp hybrids along one axis. This limits their electrical conductivity and accounts for the generally lower electrical conductivity of Group II elements (the 2^{nd} column in the periodic table). Consider diamond. As discussed above, for the purpose of determining orthogonality, diamond has traditional sp³ orbitals. These are mutually orthogonal. Electrons cannot pass through the carbon atoms. Diamond is an insulator.

Intermolecular Bonding—According to the present method, intermolecular bonds are similar to the intramolecular bonds but differ in two important respects. First, valence orthogonalization is limited to node formation as described in conjunction with parallel bonding above. Secondly, when one of the atoms of the intermolecular bond is involved in an intramolecular sigma bond, the fraction_bonding of the intermolecular bond is limited to ≤0.25 and the total intermolecular overlap≤0.333. When both of the atoms of the intermolecular bond are involved in intramolecular sigma bonds, the fraction_bonding of the intermolecular bond is limited to ≤0.125 and the total intermolecular overlap ≤0.1428. According to the present method, all possible overlaps must be considered in the calculation of intermolecular overlap. Consider, for example, the hydrogen bond in ice. This is a bond between a hydrogen of the water molecule and a (intermolecular) non-bonding electron pair on the oxygen of an adjacent water molecule. The hydrogen overlaps with both electrons of the oxygen non-bonding electron pair. These overlaps plus several secondary and tertiary intermolecular overlaps bring the total of the overlaps to 0.333 and fraction_bonding=0.25. Consider H—H intermolecular bonds in hydrocarbons and consider that the intermolecular H is three-coordinate (bonding to three Hs on other molecules). Here the overlap between each pair of Hs is 0.0476, the total overlap is 0.1428 and fraction_bonding=0.125.

The disclosure and all of the functional operations described herein can be implemented in digital electronic circuitry, or in computer hardware, firmware, software, or in combinations of them. The disclosure can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the disclosure can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array), an ASIC (application-specific integrated circuit), or the like.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

One aspect of the present disclosure is a method and process to determine chemical structure and energy and other properties such as dipole moment wherein: a quantity called fraction_bonding is calculated as fraction_bonding=overlap/(1.0+overlap) where overlap is the overlap of the bonding orbitals on each side of the bond which have been made synchronous, and the kinetic energy reduction associated with the overlap (KE_{bond}) is KE_{bond}=2·fraction_bonding KEₙₑₜ where KEₙₑₜ=KE_{ψl+r}−KE_{ψl}−KE_{ψr} where KE_{ψl} and KE_{ψr} are the kinetic energies of the left and right side synchronous orbitals and KE_{ψl+r} is the kinetic energy of a combined orbital which is formed taking the square root of the sum of the electron densities of ψ₁ and ψᵣ, the synchronous bonding orbitals, and when both bonding atoms have more than one orbital that has the appropriate symmetry for sigma bonding, dual or parallel sigma bonding occurs, and because overlap cannot exceed 1.0 and fraction_bonding cannot exceed 0.5, bond lengths are limited to distances where fraction_bonding≤0.5 and the energy penalty associated with the orthogonalization necessary to meet the requirements of the Pauli principle are taken only to the extent of (1.0−fraction_bonding). The hybridization of orbitals on the central atoms of poly-atomics is determined by the availability of s orbital character, and the kinetic energy reduction associated with the overlap of orbitals with pi symmetry (KE_{bond}_{_}_{π}) is KE_{bond}_{_}_{π}=2·fraction_bonding_{π}·KEₙₑₜ_{_}_{π} where KEₙₑₜ_{_}_{π}=KE_{combined}_{_}_{π}−KE_{π}_{_}₁−KE_{π}_{_}ᵣ where KE_{π}_{_}₁ and KE_{π}_{_}ᵣ are the kinetic energies of the left and right side pi orbitals and KE_{combined}_{_}_{π} is the kinetic energy of a combined orbital which is formed taking the square root of the sum of the electron densities of the pi orbitals, and the kinetic energy reduction associated with resonance, KE_{bond}_{_}ᵣₑₛ, is KE_{bond}_{_}ᵣₑₛ=0.5·KEₙₑₜ where KE_{bond}_{_}ᵣₑₛ is the kinetic energy reduction associated with a bonding electron which is completely free to move such as [L−R+, LR] (right electron freely moving) or [L+R−, LR] (left electron freely moving). Secondary, tertiary, and subsequent bonding in poly-atomic molecules is the same as the primary bonding but with the quantization of the primary is retained in the subsequent bonds and the subsequent bonding reduced by the extent of previous bonding of the least bonding of the previous orbitals and the total overlap calculated along principle axis of quantization which is the primary bond axis. In metals where there is no primary bond axis which is distinct from a secondary bond axis, the total bond overlap is determined by summing the overlap components along the Cartesian axes, and the fraction_bonding between metal atoms along a given axis is reduced equally by the total extent of fraction_bonding on that axis (usually 0.5) and the angle between ligands in a poly-atomic, or between a ligand and a nonbonding electron or electron pair, is the arccosine (a cos) of (−fraction of axis common to a bond and the opposing bond/lone pair).

In some embodiments, synchronous orbitals are orbitals which are processed so that, at every position in space, they have the same sign. In some embodiments, hybrid sigma bonding orbitals of the form ψᵣ=fs_{br} s+fp_{br} p_{z} and ψ₁=fs_{brl} s+fp_{bl} p_{z} the quantities overlap and KE_{bond} are given by: overlap=fs_{bl}·fs_{br}·overlapₛ₋ₛ+fp_{bl}·fp_{br}·overlap_{pz-pz}+fp_{bl}·fs_{br}·overlap_{pz-s}+fs_{bl}·fp_{br}·overlap_{s-pz}, KE_{bond}=(1.0/(1.0+overlap)) ·(fs_{bl}·fs_{br}·overlapₛ₋ₛ·KEₙₑₜₛ₋ₛ+fp_{bl}·fp_{br}·overlap_{pz-pz}·KE_{netpz-pz}+fp_{b1}·fs_{br}·overlap_{pz-s}·KE_{netpz-s}+fs_{bl}·fp_{br}·overlap_{s-pz}·KE_{nets-pz}).

In certain other embodiments, for a bond between two atoms, each of which has two orbitals of sigma symmetry, where the second set does not reconfigure to orthogonalize, fraction_bonding=fraction_bonding₁+fraction_bonding₂, and KE_{bond}=KE_{bond 1}+KE_{bond 2}.

Another aspect of the method is an analytical procedure which, after making the node locations on the two bonding orbitals coincident, iteratively smooths the charge density while maintaining the bonding orbital density distribution as closely as possible to the original bonding orbitals.

In certain embodiments, two sets of arrays are used, one for the kinetic energy and electron-nuclear attraction calculations and another, courser set of arrays for the electron-electron repulsion calculations each of these two sets of arrays broken into multiple sets of overlapping subarrays; fine arrays close to the bond axis and courser arrays further from the bond axis and further from the bond center, and for each subarray, there are separate associated arrays containing the position of the array element on the bond axis, the position outward along the radius, and the distances to the nuclei, and the radial distance between each of every pair of subarray elements is contained in tables which have been generated off-line.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

Previous attempts to develop a general method to calculate the structure and energetics of chemical compounds have largely failed. Although methods based on various theories of chemical bonding, such as the popular molecular orbital theory are qualitatively satisfying, they fail to produce accurate quantitative results when applied in the first order. Although it is possible to improve those first order results by using increasingly complex functions to describe the bonding electrons, it is fair to say that there is currently no generally applicable method for solving the chemical bond. The problem is to develop a generally applicable, accurate method to solve the chemical bond which is comprehensible to the average researcher. The methods described herein solve that problem. Herein is demonstrated a general method for solving for bond lengths, bond energies, bond angles, and other chemical properties which starts with Slater-type atomic orbitals (s,p,d, etc.). Key to the method is the recognition that overlapping bonding atomic orbitals, even though they are of opposite spin, are not completely distinguishable. The method exploits the various ramifications of the partial indistinguishability of the bonding orbitals. The method generally calculates bond energies to 1-2% and bond lengths to 0.005 Å. Calculations for six bond lengths run in a few seconds on a desktop computer. It is anticipated that this method could be utilized to produce a program which would simulate chemical behavior. Since the calculations are quite fast it is possible to anticipate the simulation of interactions of biological interest as well.

What is claimed:

1. A computer program product, tangibly stored on a computer-readable medium, the product comprising instructions operable to cause a programmable processor to perform for modeling the stability and structure of a molecule comprising determining a geometry and an electronic configuration or pair of electronic configurations for a bond in a molecule;
determining one or more central atom bonding hybrid orbital coefficients for polyatomic molecules;
selecting a bond length;
generating one or more atomic orbitals using at least two arrays;
determining opposing hybrid orbital coefficients for terminal atoms;
calculating potential energy terms;
calculating an energy required to promote an s orbital to a p orbital;
synchronizing a sigma bonding orbital to an opposite sigma bonding orbital;
orthogonalizing a sigma bond orbital on a first atom to core electrons of an orbital on an opposite atom;
calculating a core orthogonality energy penalty for a pair of sigma bonding orbitals;
calculating sigma overlap for the pair or two pairs of sigma bonding orbitals;
calculating fraction_bonding for the pair or two pairs of sigma bonding orbitals;
calculating kinetic energy for the pair or two pairs of sigma bonding orbitals;
calculating pi bonding;
calculating secondary and tertiary interactions;
determining if an alternate configuration or geometry is possible; and
finalizing a model comprising the stability and structure of a molecule.

2. The computer program product of claim 1, wherein the at least two arrays comprise a first array for kinetic energy and electron-nuclear attraction calculations and a second array for electron-electron repulsion calculations.

3. The computer program product of claim 2, wherein the first and second array are further divided into multiple sets of overlapping subarrays, finer arrays are used closer to a bond axis and coarser arrays are used farther from the bond axis and a bond center.

4. The computer program product of claim 3, wherein the subarrays there are associated arrays comprising a position of an array element on a bond axis, a position outward along a radius, and a distance to a nuclei.

5. The computer program product of claim 1, wherein orthogonalizing a sigma bond orbital in a first atom to core electrons of an orbital on an opposite atom further comprises the steps of making node locations coincident and maintaining orbital density distribution.

6. A method for modeling the stability and structure of chemicals comprising,
determining a first geometry and a first electronic configuration or pair of electronic configurations for a bond in a molecule;
determining one or more central atom bonding hybrid orbital coefficients for polyatomic molecules;
selecting a bond length;
generating one or more atomic orbitals using at least two arrays;
determining opposing hybrid orbital coefficients for terminal atoms;
calculating potential energy terms;
calculating an energy required to promote an s orbital to a p orbital;
synchronizing a sigma bonding orbital to an opposite sigma bonding orbital;
orthogonalizing a sigma bond orbital in a first atom to core electrons of orbital on an opposite atom;
calculating a core orthogonality energy penalty for a pair of sigma bonding orbitals;
calculating sigma overlap for the pair or two pairs of sigma bonding orbitals;
calculating fraction_bonding for the pair or two pairs of sigma bonding orbitals;
calculating kinetic energy for the pair or two pairs of sigma bonding orbitals;
calculating pi bonding;
calculating secondary and tertiary interactions;
determining if an alternate configuration or geometry is possible; and
finalizing a model comprising the stability and structure of a molecule.

7. The method of claim 6, wherein at least two arrays comprise a first array for kinetic energy and electron-nuclear attraction calculations and a second array for electron-electron repulsion calculations.

8. The method of claim 7, wherein the first and second array are further divided into multiple sets of overlapping subarrays, finer arrays are used closer to a bond axis and coarser arrays are used farther from the bond axis and a bond center.

9. The method of claim 8, wherein the subarrays there are associated arrays comprising a position of an array element on a bond axis, a position outward along a radius, and a distance to a nuclei.

10. The method of claim 6, wherein orthogonalizing a sigma bond orbital in a first atom to core electrons of an orbital on an opposite atom further comprises the steps of making node locations coincident and maintaining orbital density distribution.
